(19) United States
(12) Patent Application Publication
(10) Pub. No.: US 2026/0246126 A1
(43) Pub. Date: Aug. 20, 2026

(54) DIGITAL PHASE SHIFT CIRCUIT AND DIGITAL PHASE SHIFTER

(71) Applicant: Fujikura Ltd., Tokyo (JP)

(72) Inventor: Yusuke Uemichi, Sakura-shi (JP)

(73) Assignee: Fujikura Ltd., Tokyo (JP)

(21) Appl. No.: 19/489,617

(22) PCT Filed: Jun. 7, 2024
(86) PCT No.: PCT/JP2024/020933

§ 371 Date: Dec. 3, 2025

(30) Foreign Application Priority Data
Jun. 7, 2023 (JP) 2023-093908

(51) Int. Cl. H01P 1/18

(52) U.S. Cl. CPC H01P 1/184

(57) ABSTRACT

A digital phase shift circuit (B) includes a signal line (10), a first line (21) including a first parallel line (21p1), a second line (22) including a second parallel line (22p2) and a loop line (22L), a first ground conductor (31), a second ground conductor (32), a first electronic switch (41), and a second electronic switch (42), in which the signal line (10) is located between the first parallel line (21p1) and the second parallel line (22p2), and the loop line (22L) includes a first loop line section (22L1) formed in a first layer in which the signal line (10), the first parallel line (21p1), and the second parallel line (22p2) are formed, and a second loop line section (22L2) electrically connected to the first loop line section (22L1) through a via and formed in a second layer different from the first layer.

### TECHNICAL FIELD

The present disclosure relates to a digital phase shift circuit and a digital phase shifter.

Priority is claimed on Japanese Patent Application No. 2023-093908, filed Jun. 7, 2023, the content of which is incorporated herein by reference.

### BACKGROUND ART

Non-Patent Document 1 shown below discloses a digital control type phase shift circuit (digital phase shift circuit) for microwaves, quasi-millimeter waves, or millimeter waves. The digital phase shift circuit includes, as shown in FIG. 2 of Non-Patent Document 1, a signal line, a pair of inner lines, a pair of outer lines, a first ground bar, a second ground bar, a pair of NMOS switches, and the like. The pair of inner lines are provided on both sides of the signal line. The pair of outer lines are provided outside the pair of inner lines. The first ground bar is connected to one end of each inner line and one end of each outer line. The second ground bar is connected to the other end of each outer line. Each of the NMOS switches is provided between the other end of each of the inner lines and the second ground bar.

In such a digital phase shift circuit, an operation mode is switched between a low-delay mode and a high-delay mode by switching, in accordance with opening/closing of the pair of NMOS switches, a return current flowing through the pair of inner lines or the pair of outer lines in response to the transmission of signal waves in the signal line. That is, in the digital phase shift circuit, the operation mode becomes the low-delay mode in a case where the return current flows through the pair of inner lines, and the operation. mode becomes the high-delay mode in a case where the return current flows through the pair of outer lines.

### Citation List

### Non-Patent Literature

Non-Patent Document 1: A Ka-band Digitally-Controlled Phase Shifter with sub-degree Phase Precision (2016, IEEE, RFIC)

### SUMMARY OF INVENTION

### Technical Problem

In the digital phase shift circuit as described above, in order to ensure a phase shift amount in a limited area, it is desirable that, for the inductance that is one of the circuit constants, a value (inductance value) in the high-delay mode is sufficiently larger than an inductance value in the low-delay mode. However, in the above-described digital phase shift circuit in the related art, in order to increase the inductance value in the high-delay mode, it is necessary to separate the outer lines from the signal line (or to increase the length of the outer lines), and thus the size thereof increases. Since the digital phase shifter has a configuration in which a plurality of digital phase shift circuits are cascade-connected, the digital phase shifter is increased in size in a case where the size of the digital phase shift circuit is increased.

The present disclosure has been made in view of the above-described circumstances, and an object of the present disclosure is to provide a digital phase shift circuit and a digital phase shifter that can achieve desired phase shift characteristics with a smaller size than in the related art.

### Solution to Problem

In order to achieve the above described object, a digital phase shift circuit (B, B′) according to a first aspect of the present disclosure includes: a signal line (10); a first line (21) including a first parallel line (21p1) extending parallel to the signal line; a second line (22) including a second parallel line (22p2) and a loop line (22L), the second parallel line extending parallel to the signal line, and the loop line extending from one end portion of the second parallel line to a vicinity of the other end portion of the second parallel line in plan view and being convex in a direction away from the signal line in a crossing direction (Y) crossing a longitudinal direction of the signal line; a first ground conductor (31) electrically connected to one end portion of the first parallel line and the one end portion of the second parallel line; a second ground conductor (32) connected to one end portion of the second line; a first electronic switch (41) provided between the other end portion of the first parallel line and the second ground conductor; and a second electronic switch (42) provided between the other end portion of the second parallel line and the second ground conductor, in which the signal line is located between the first parallel line and the second parallel line, and the loop line includes a first loop line section (22L1) and a second loop line section (22L2), the first loop line section being formed in a first layer in which the signal line, the first parallel line, and the second parallel line are formed, and the second loop line section being electrically connected to the first loop line section through a via (23) and being formed in a second layer different from the first layer.

In the digital phase shift circuit according to the first aspect of the present. disclosure, in a low-delay mode in which the first electronic switch and the second electronic switch are set to a closed state, a first return current flows through the first parallel line that forms a part of the first line, and a second return current flows through the second parallel line that forms a part of the second line. On the other hand, in a high-delay mode in which the first electronic switch and the second electronic switch are set to an off state, a third return current flows through the loop line having a three-dimensional structure in which the first loop line section and the second loop line section are formed in different layers and are connected to each other through the via. As a result, the inductance value can be increased, and thus desired phase shift characteristics can be achieved with a small size compared to the related art.

A digital phase shift circuit according to a second aspect of the present disclosure is that in the digital phase shift circuit according to the first aspect of the present disclosure, the second loop line section has a portion that is a narrowed-width line section (22p3, 22c3, 22w1, 22w2) having a smaller width than other portions of the second loop line section.

A digital phase shift circuit according to a third aspect of the present disclosure is that in the digital phase shift circuit according to the first or second aspect of the present disclosure, the second loop line section has a smaller thickness than the first loop line section.

A digital phase shift circuit according to a fourth aspect of the present disclosure is that in the digital phase shift circuit according to any one of the first to third aspects of the present disclosure, the second layer in which the second loop line section is formed is an inner layer relative to the first layer in which the first loop line section is formed.

A digital phase shift circuit according to a fifth aspect of the present disclosure is that in the digital phase shift circuit according to any one of the first to fourth aspects of the present disclosure, both ends of the second loop line section are via pads (VP21, VP22) to which the via is connected, and a plurality of the vias are connected to each of the via pads.

A digital phase shift circuit according to a sixth aspect of the present disclosure is that in the digital phase shift circuit according to the fifth aspect of the present disclosure, the vias at both ends of the second loop line section are arranged such that arrangement directions of the vias are parallel to each other or orthogonal to each other.

A digital phase shift circuit according to a seventh aspect of the present disclosure is that in the digital phase shift circuit according to the sixth aspect of the present disclosure, a portion of the second loop line section other than the via pads is a narrowed-width line section (22p3, 22c3, 22w1, 22w2) having a smaller width than widths of the via pads.

A digital phase shift circuit according to an eighth aspect of the present disclosure is that in the digital phase shift circuit according to any one of the first to seventh aspects of the present disclosure, a via pad (VP31) is formed between the first loop line section and the second loop line section in a direction of plan view, and the first loop line section and the second loop line section are electrically connected to each other through the via pad.

A digital phase shift circuit according to a ninth aspect of the present disclosure is that the digital phase shift circuit according to any one of the first to eighth aspects of the present disclosure further includes: a capacitor (60) connected to one end portion of the signal line; and a third electronic switch (43) provided between the capacitor and the first ground conductor, in which one end portion of the first ground conductor extends away from the signal line in the crossing direction and is connected to the third electronic switch.

A digital phase shift circuit according to a tenth aspect of the present disclosure is that in the digital phase shift circuit according to the ninth aspect of the present disclosure, the first electronic switch, the second electronic switch, and the third electronic switch are field-effect transistors, and sizes of the field-effect transistors forming the first electronic switch and the second electronic switch are twice or more a size of the field-effect transistor forming the third electronic switch.

A digital phase shift circuit according to an eleventh aspect of the present disclosure is that the digital phase shift circuit according to any one of the first to tenth aspects of the present disclosure further includes: a first upper pad (21d2) provided at the other end portion of the first parallel line; and a second upper pad (22d) provided at the other end portion of the second parallel line, in which a maximum value of a dimension of the first upper pad in the crossing direction is larger than a width of the first parallel line, and a maximum value of a dimension of the second upper pad in the crossing direction is larger than a width of the second parallel line.

A digital phase shift circuit according to a twelfth aspect of the present disclosure is that the digital phase shift circuit according to the eleventh aspect of the present disclosure further includes: a first lower pad (33a) connected to the first upper pad through a via (50) and to which the first electronic switch is connected; and a second lower pad (33b) connected to the second upper pad through a via (50) and to which the second electronic switch is connected, in which a maximum value of a dimension of the first lower pad in the crossing direction is larger than the maximum value of the dimension of the first upper pad in the crossing direction, and a maximum value of a dimension of the second lower pad in the crossing direction is larger than the maximum value of the dimension of the second upper pod in the crossing direction.

A digital phase shift circuit according to a thirteenth aspect of the present disclosure is that the digital phase shift circuit according to any one of the first to twelfth aspects of the present disclosure further includes: a fourth electronic switch (44) provided between one end portion of the signal line and the first ground conductor.

A digital phase shifter (A1, A2, A21 to A23) according to a first aspect of the present disclosure includes: a plurality of digital phase shift circuits (B₁ to Bₙ) that are cascade-connected, in which each of the digital phase shift circuits is the digital phase shift circuit according to any one of claims 1 to 13, and the first ground conductor and the second ground conductor are integrated in a portion in which the digital phase shift circuits are adjacent to each other.

### Advantageous Effects of Invention

According to the present disclosure, there is an effect that desired phase shift characteristics can be achieved with a smaller size than in the related art.

### BRIEF DESCRIPTION OF DRAWINGS

FIG. 1 A plan view showing a basic configuration of a digital phase shift circuit according to a first embodiment of the present disclosure.

FIG. 2 A cross-sectional view taken along line II-II in FIG. 1.

FIG. 3 A cross-sectional view taken along line III-III in FIG. 1.

FIG. 4 A perspective view showing a part of a loop line in the digital phase shift circuit according to the first embodiment of the present disclosure.

FIG. 5 A plan view showing a connection relationship between a connection pads and first and second electronic switches in the digital phase shift circuit according to the first embodiment of the present disclosure.

FIG. 6 A plan view showing a configuration of main parts of a digital phase shifter according to the first embodiment of the present disclosure.

FIG. 7 A plan view showing a basic configuration of a digital phase shift circuit according to a second embodiment of the present disclosure.

FIG. 8 A perspective view showing a part of a loop line in the digital phase shift circuit according to the second embodiment of the present disclosure,

FIG. 9 A plan view showing a configuration of main parts of a digital phase shifter according to the second embodiment of the present disclosure.

FIG. 10 A plan view showing a modification example of the digital phase shifter according to the second embodiment of the present disclosure.

FIG. 11 A plan view showing a modification example of the digital phase shifter according to the second embodiment of the present disclosure.

FIG. 12 A plan view showing a modification example of the digital phase shifter according to the second embodiment of the present disclosure.

FIG. 13 A cross-sectional view showing another example configuration of the loop line.

### DESCRIPTION OF EMBODIMENTS

Hereinafter, a digital phase shift circuit and a digital phase shifter according to embodiments of the present disclosure will be described in detail with reference to the drawings. In the drawings to be referred to below, for the sake of easy understanding, the dimensions of each component are changed as appropriate as necessary.

### First Embodiment

### Digital Phase Shift Circuit

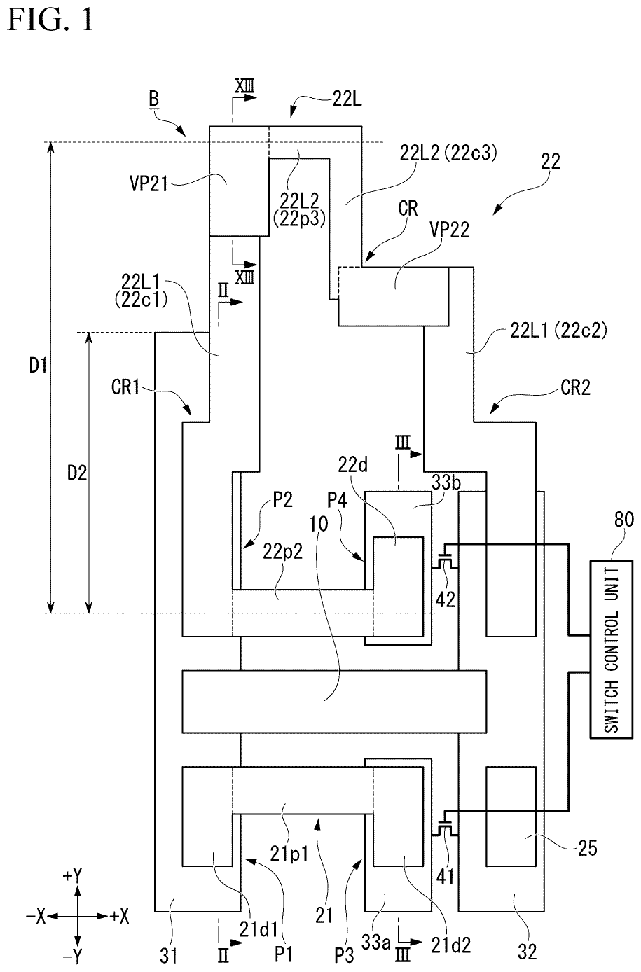

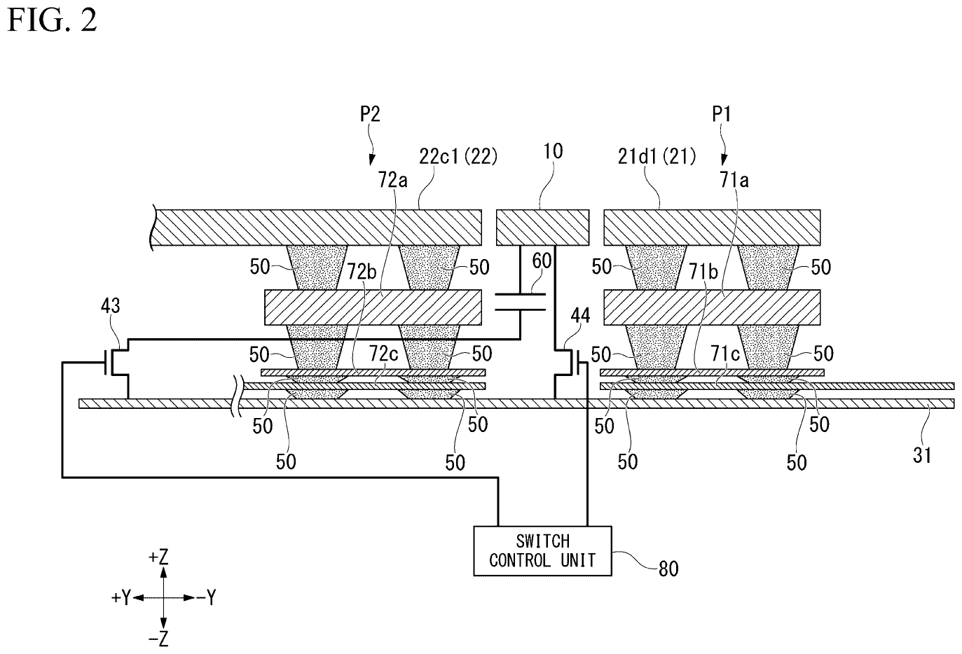

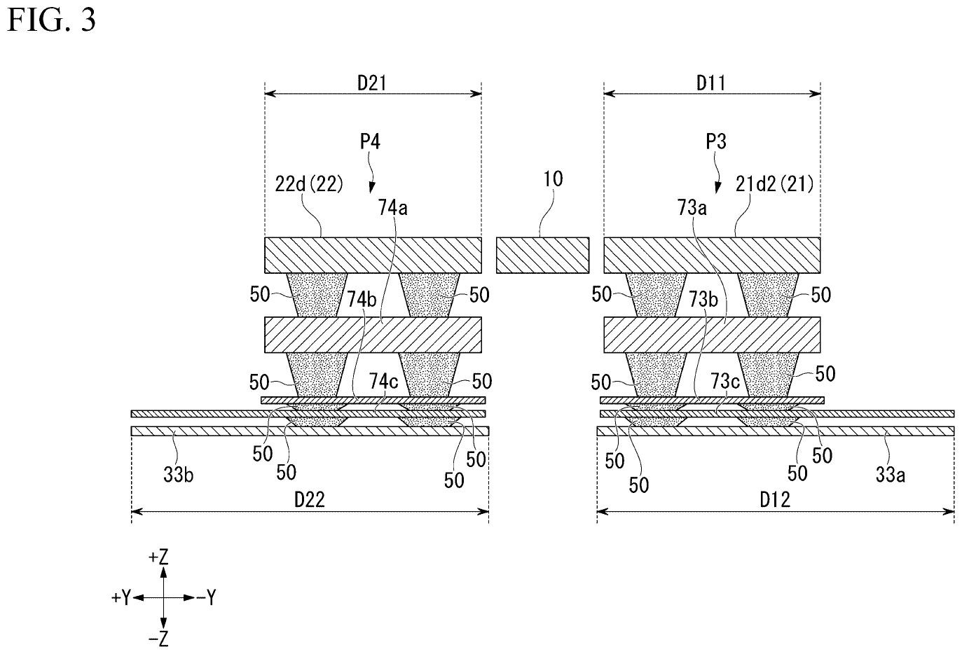

FIG. 1 is a plan view showing a basic configuration of a digital phase shift circuit according to a first embodiment of the present disclosure. FIG. 2 is a cross-sectional view taken along line II-II in FIG. 1. FIG. 3 is a cross-sectional view taken along line III-III in FIG. 1.

As shown in FIG. 1, a digital phase shift circuit B includes a signal line 10, a first line 21, a second line 22, an upper pad 25, a first ground conductor 31, and a second ground conductor 32. The first line 21 of the present embodiment includes a first parallel line 21p1 and a pair of upper pads 21d1 and 21d2, The second line 22 of the present embodiment includes a second parallel line 22p2, a loop line 22L, and an upper pad 22d. In addition, the digital phase shift circuit B of the present embodiment includes four electronic switches 41 to 44, a plurality of connection conductors 50, a capacitor 60, and a plurality of connection pads P1 to P4 (see also FIGS. 2 and 3).

As shown in FIG. 1, the signal line 10 is a straight strip-shaped conductor extending in one direction. That is, the signal line 10 is an elongated plate-shaped conductor having a constant width, a constant thickness, and a predetermined length. In the signal line 10, a signal current flows from a left side of a paper surface to the right side of the paper surface in FIG. 1, that is, from a left-side end portion (input end) of the paper surface to a right-side end portion (output end) of the paper surface. This signal current is a high-frequency signal having a wavelength range of the microwaves, the quasi-millimeter waves, or the millimeter waves described above.

Here, in the present embodiment, a longitudinal direction of the signal line 10 (direction in which the signal line 10 extends) is simply referred to as a longitudinal direction X. A direction from the input end to the output end of the signal line 10 in the longitudinal direction X is referred to as a +X direction or a right side. A direction opposite to the right side is referred to as a left side or a −X direction. A direction crossing (for example, orthogonal to) the signal line 10 is referred to as a crossing direction Y. One direction parallel to the crossing direction Y is referred to as a rear side or a +Y direction. A direction opposite to the rear side is referred to as a front side or a −Y direction. A direction crossing (for example, orthogonal to) both the longitudinal direction X and the crossing direction Y is referred to as an up-down direction Z. One direction parallel to the up-down direction Z is referred to as an upper side or a +Z direction. A direction opposite to the upper side is referred to as a lower side or a −Z direction. A view viewed in the up-down direction Z is referred to as plan view.

The signal line 10 has, electrically, an inductance L1 as a lumped-constant circuit element. This inductance L1 is a parasitic inductance having magnitude corresponding to the shape of the signal line 10, such as the length of the signal line 10. Further, the signal line 10 also has, electrically, a capacitance C1 as a lumped-constant circuit element. This capacitance C1 is a parasitic capacitance between the signal line 10 and a first parallel line 21p1 (described later in detail), between the signal line 10 and a second parallel line 22p2 (described later in detail), between the signal line 10 and a third parallel line 22p3 (described later in detail), between the signal line 10 and a silicon substrate (not shown), and the like.

The first parallel line 21p1 is a straight strip-shaped conductor provided on the other side (−Y side) of the signal line 10. The first parallel line 21p1 is an elongated plate-shaped conductor having a constant width, a constant thickness, and a predetermined length. The first parallel line 21p1 extends parallel to (in the longitudinal direction X of) the signal line 10. The first parallel line 21p1 and the signal line 10 are disposed with a spacing therebetween in the crossing direction Y.

The upper pad 21d1 is a rectangular flat plate conductor that is connected to one end (−X side) of the first parallel line 21p1. Long sides of the upper pad 21d1 extend in the crossing direction Y, and short sides of the upper pad 21d1 extend in the longitudinal direction X. One short side (+Y side) of the upper pad 21d1 is located at substantially the same position, in the crossing direction Y, as one side edge (+Y side) of the first parallel line 21p1. Further, the other short side (−Y side) of the upper pad 21d1 is located on the front side (−Y side) of the other side edge (−Y side) of the first parallel line 21p1, That is, a dimension of the upper pad 21d1 in the crossing direction Y is larger than the width (dimension in the crossing direction Y) of the first parallel line 21p1.

The upper pad 21d2 is a rectangular flat plate conductor that is connected to the other end (+X side) of the first parallel line 21p1. Long sides of the upper pad 21d2 extend in the crossing direction Y, and short sides of the upper pad 21d2 extend in the longitudinal direction X. One short side (+Y side) of the upper pad 21d2 is located at substantially the same position, in the crossing direction Y, as one side edge (+Y side) of the first parallel line 21p1. Further, the other short side (−Y side) of the upper pad 21d2 is located on the front side (−Y side) of the other side edge (−Y side) of the first parallel line 21p1. That is, a dimension of the upper pad 21d2 in the crossing direction Y is larger than the width (dimension in the crossing direction Y) of the first parallel line 21p1.

The second parallel line 22p2 is a straight strip-shaped conductor provided on one side (+Y side) of the signal line 10. The second parallel line 22p2 is an elongated plate-shaped conductor having a constant width, a constant thickness, and a predetermined length. The second parallel line 22p2 extends parallel to (in the longitudinal direction X of) the signal line 10. The second parallel line 22p2 and the signal line 10 are disposed with a spacing therebetween in the crossing direction Y.

The second parallel line 22p2 is provided on an opposite side to the first parallel line 21p1 with respect to the signal line 10. Stated another way, the second parallel line 22p2 is disposed such that the signal line 10 is located between the first parallel line 21p1 and the second parallel line 22p2 in the crossing direction Y.

The loop line 22L is provided on an opposite side to the first parallel line 21p1 with respect to the signal line 10, as in the second parallel line 22p2. The loop line 22L is a line that extends from one end (−X end) of the second parallel line 22p2 to the vicinity of the other end (+X end) of the second parallel line 22p2 in plan view and is convex toward the rear side (+Y side).

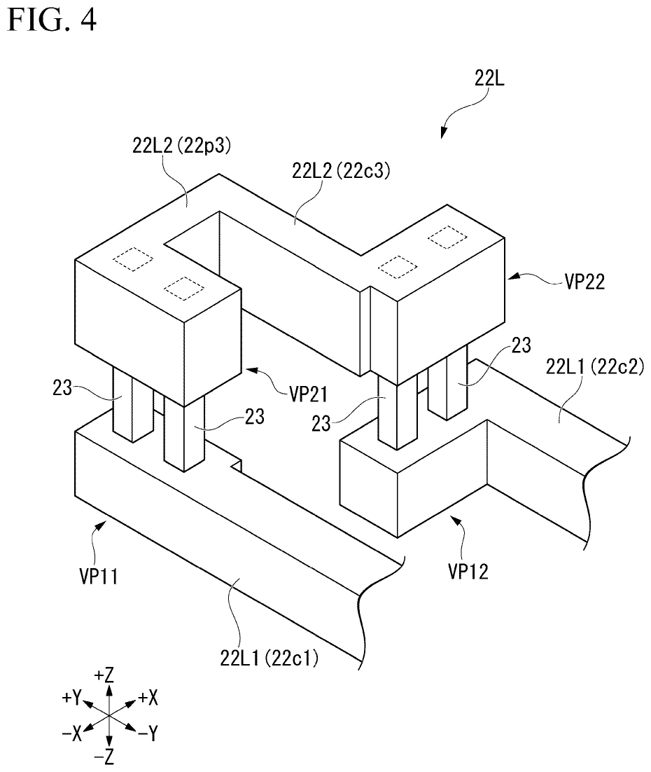

FIG. 4 is a perspective view showing a part of the loop line in the digital phase shift circuit according to the first embodiment of the present disclosure. As shown in FIGS. 1 and 4, the loop line 22L includes a first loop line section 22L1 and a second loop line section 22L2. The first loop line section 22L1 is formed in a layer (first layer) in which the signal line 10, the first parallel line 21p1, and the second parallel line 22p2 are formed. The second loop line section 22L2 is formed in a layer (second layer) different from the layer in which the first loop line section 22L1 is formed. In the present embodiment, the second loop line section 22L2 is formed in an outer layer (+Z side layer) relative to the first loop line section 22L1. As shown in FIG. 4, the first loop line section 22L1 and the second loop line section 22L2 are electrically connected to each other through a plurality of vias 23.

That is, the loop line 22L has a three-dimensional structure in which the first loop line section 22L1 and the second loop line section 22L2 formed in different layers are connected to each other through the vias 23. Although details will be described later, the loop line 22L has a three-dimensional structure in order to increase inductance of the loop line 22L.

The first loop line section 22L1 includes a first crossing line 22c1 and a second crossing line 22c2. The first crossing line 22e1 is a strip-shaped conductor connected to one end (−X side) of the second parallel line 22p2. A bent portion CR1 is formed in the first crossing line 22c1, and a side of the first crossing line 22c1 close to the second parallel line 22p2 (for example, the second parallel line 22p2 side with respect to a position of a midpoint of the first crossing line 22c1 in the Y direction) has a crank shape. The first crossing line 22c1 extends from one end (−X side) of the second parallel line 22p2 to be away from the signal line 10 in the crossing direction Y, is bent to the right side (+X side) at the bent portion CR1, and then extends to be away from the signal line 10 in the crossing direction Y again.

An end edge (−Y side) of the first crossing line 22c1 on the front side is located at substantially the same position as one side edge (−Y side) of the second parallel line 22p2 in the crossing direction Y. A rear end portion (+Y side) of the first crossing line 22c1 is a via pad VP11 to which the via 23 is connected (see FIG. 4). The via pad VP11 has a rectangular shape in which long sides extend in the crossing direction Y and short sides extend in the longitudinal direction X in plan view. The via pad VP11 is electrically connected to a via pad VP21 (described later in detail) at one end of the second loop line section 22L2 through the plurality of vias 23.

The second crossing line 22c2 is a strip-shaped conductor electrically connected to the other end of the second loop line section 22L2. A bent portion CR2 is formed in the second crossing line 22c2, and a side of the second crossing line 22c2 close to the second parallel line 22p2 (for example, the second parallel line 22p2 side with respect to a position of a midpoint of the second crossing line 22c2 in the Y direction) has a crank shape. In plan view, a portion of the second crossing line 22c2 overlapping the other end of the second loop line section 22L2 extends to the right side (+X side), the second crossing line 22c2 extends from the other end (+X end) of the overlapping portion to approach the signal line 10 in the crossing direction Y, is bent to the right side (+X side) at the bent portion CR2, and then extends to approach the signal line 10 in the crossing direction Y again.

A rear end portion (+Y side) of the second crossing line 22c2 is a via pad VP12 to which the via 23 is connected (see FIG. 4). The via pad VP12 has a rectangular shape in which long sides extend in the longitudinal direction X and short sides extend in the crossing direction Y in plan view. The via pad VP12 of the second crossing line 22c2 is electrically connected to a via pad VP22 (described later in detail) at the other end of the second loop line section 22L2 through the plurality of vias 23.

One end edge (−Y side) of the second crossing line 22c2 is located at substantially the same position, in the crossing direction Y, as one short side (−Y side) of the upper pad 22d and one side edge (−Y side) of the second parallel line 22p2. Further, the upper pad 22d and the second crossing line 22c2 are disposed with a spacing therebetween in the longitudinal direction X. In addition, the left side edge (−X side) at one end (−Y side) of the second crossing line 22c2 of the present embodiment is located at substantially the same position, in the longitudinal direction X, as a right end edge (+X side) of the signal line 10.

In addition, one end (−Y side) of the second crossing line 22c2 of the present embodiment is electrically connected to the second ground conductor 32 (described later) through a conductor (not shown) at all times. Stated another way, one end of the second line 22 is electrically connected to the second ground conductor 32 through the conductor (not shown) at all times.

The second loop line section 22L2 is a strip-shaped conductor including the third parallel line 22p3 (narrowed-width line section) and a third crossing line 22c3 (narrowed-width line section), one end of the second loop line section 22L2 is the via pad VP21, and the other end of the second loop line section 22L2 is the via pad VP22. The third parallel fine 22p3 is a straight strip-shaped conductor connected to one end (+Y end) of the via pad VP21. The third parallel line 22p3 is a conductor having a constant width, a constant thickness, and a predetermined length. The third parallel line 22p3 extends from one end (+Y side) of the via pad VP21 and parallel to (in the longitudinal direction X of) the signal line 10. That is, the third parallel line 22p3 of the present embodiment extends from one end (+Y side) of the via pad VP21 toward the right side (+X side). The length of the third parallel line 22p3 is shorter than the length of the second parallel line 22p2.

In plan view, the third parallel line 22p3 is provided at one side edge (+Y side) of the signal line 10 at a position farther from the signal line 10 than the second parallel line 22p2. Stated another way, the third parallel line 22p3 is disposed such that the second parallel line 22p2 is located between the signal line 10 and the third parallel line 22p3 in the crossing direction Y.

As shown in FIG. 1, in plan view, in the crossing direction Y, a distance D1 between a center line of the second parallel line 22p2 and a center line of the third parallel line 22p3 is larger than a distance D2 between the center line of the second parallel line 22p2 and the outer edge (outer edge on the third parallel line 22p3 side) on the rear side of the first ground conductor 31 (described later).

The third crossing line 22c3 is a straight strip-shaped conductor that extends from the other end (+X side) of the third parallel line 22p3 to approach the signal line 10 in the crossing direction Y and is connected to one end (−X side) of the via pad VP22. The third crossing line 22c3 is a conductor having a constant width, a constant thickness, and a predetermined length. The length of the third crossing line 22c3 is shorter than the length of the first crossing line 22c1. A bent portion CR is formed of the third crossing line 22c3 and the via pad VP22.

The widths of the third parallel line 22p3 and the third crossing line 22c3 are narrower than the widths (lengths of the short sides) of the via pads VP21 and VP22. That is, the second loop line section 22L2 includes the third parallel line 22p3 and the third crossing line 22c3 that are narrowed-width line sections having a smaller width than other portions of the second loop line section 22L2. Stated another way, the portions (third parallel line 22p3 and third crossing line 22c3) of the second loop line section 22L2 other than the via pads VP21 and VP22 are narrowed-width line sections having a smaller width than the widths of the via pads VP21 and VP22.

The via pad VP21 has a rectangular shape in which long sides extend in the crossing direction Y and short sides extend in the longitudinal direction X. The via pad VP21 is disposed to overlap the via pad VP11 in the up-down direction Z. The via pad VP21 and the via pad VP11 are electrically connected to each other through the plurality of vias 23. The via pad VP22 has a rectangular shape in which long sides extend in the longitudinal direction X and short sides extend in the crossing direction Y. The via pad VP22 is disposed to overlap the via pad VP12 in the up-down direction Z. The via pad VP22 and the via pad VP12 are electrically connected to each other through the plurality of vias 23,

In the via pads VP11, VP12, VP21, and VP22, the vias 23 are arranged along the long sides of each of the via pads VP11, VP12, VP21, and VP22. Specifically, the vias 23 are arranged in the crossing direction Y in the via pads VP11 and VP21, and are arranged in the longitudinal direction X in the via pads VP12 and VP22. That is, the vias 23 at both ends of the second loop line section 22L2 are arranged such that arrangement directions of the vias 23 are orthogonal to each other

The upper pad 22d is a rectangular flat plate conductor that is connected to the other end (+X side) of the second parallel line 22p2. Long sides of the upper pad 22d extend in the crossing direction Y, and short sides of the upper pad 22d extend in the longitudinal direction X. The other short side (−Y side) of the upper pad 22d is located at substantially the same position, in the crossing direction Y, as the other side edge (−Y side) of the second parallel line 22p2. Further, one short side (+Y side) of the upper pad 22d is located on the rear side (+Y side) of one side edge (+Y side) of the second parallel line 22p2. That is, a dimension of the upper pad 22d in the crossing direction Y is larger than the width (dimension in the crossing direction Y) of the second parallel line 22p2.

The upper pad 25 is a rectangular flat plate conductor similar to the upper pads 21d1 and 21d2 forming a part of the first line 21 and the upper pad 22d forming a part of the second line 22. Long sides of the upper pad 25 extend in the crossing direction Y, and short sides of the upper pad 25 extend in the longitudinal direction X. One short side (+Y side) of the upper pad 25 is located at substantially the same position, in the crossing direction Y, as one side edge (+Y side) of the first parallel line 21p1. Further, the other short side (−Y side) of the upper pad 25 is located on the front side (−Y side) of the other side edge (−Y side) of the first parallel line 21p1. That is, a dimension of the upper pad 25 in the crossing direction Y is larger than the width (dimension in the crossing direction Y) of the first parallel line 21p1, similarly to the upper pads 21d1 and 21d2 forming a part of the first line 21. Further, the upper pad 25 is electrically connected to the second ground conductor 32 through a conductor (not shown) at all times, similarly to one end (−Y side) of the second crossing line 22c2.

The first ground conductor 31 is a plate-shaped conductor provided on the input end side (+X side) of the signal line 10. The first ground conductor 31 is electrically grounded. The first ground conductor 31 has a rectangular shape in which long sides extend in the crossing direction Y and short sides extend in the longitudinal direction X. Further, the first ground conductor 31 overlaps the upper pad 21d1 and the front side (−Y side) end portion of the first crossing line 22c1 in the up-down direction Z. As shown in FIG. 2, the first ground conductor 31 is located below (on the −Z side of) the signal line 10, the first line 21 (upper pad 21d1), and the second line 22 (first crossing line 22c1),

The second ground conductor 32 is a plate-shaped conductor provided on the output end side (+X side) of the signal line 10. The second ground conductor 32 is electrically grounded. Although not shown in detail, the second ground conductor 32 is located below (on the −Z side of) the signal line 10, the first line 21, the second line 22 (second crossing line 22c2), and the upper pad 25.

As shown in FIG. 2, the first connection pad Pl includes the upper pad 21d1, a first intermediate pad 71a, a second intermediate pad 71b, a third intermediate pad 71c, and the first ground conductor 31. The upper pad 21d1, the first intermediate pad 71a, the second intermediate pad 71b, the third intermediate pad 71c, and the first ground conductor 31 overlap each other in plan view. Further, the upper pad 21d1, the first intermediate pad 71a, the second intermediate pad 71b, the third intermediate pad 71c, and the first ground conductor 31 are arranged in this order from the upper side (+Z side) to the lower side (−Z side), and are disposed with spacings therebetween in the up-down direction Z.

As shown in FIG. 2, the upper pad 21d1 and the first intermediate pad 71a are electrically and mechanically connected to each other through the plurality of connection conductors 50. Further, the first intermediate pad 71a and the second intermediate pad 71b are electrically and mechanically connected to each other through the plurality of connection conductors 50. Further, the second intermediate pad 71b and the third intermediate pad 71c are electrically and mechanically connected to each other through the plurality of connection conductors 50. Further, the third intermediate pad 71c and the first ground conductor 31 are electrically and mechanically connected to each other through the plurality of connection conductors 50. As a result, the first connection pad PI electrically connects one end (−X side) of the first parallel line 21p1 to the first ground conductor 31 at all times.

Further, in the present specification, the “connection conductor 50” is a conductor extending in the up-down direction Z, and is a member that electrically and mechanically connects a member connected to an upper end of the connection conductor 50 and a member connected to a lower end of the connection conductor 50. The connection conductor 50 is, for example, a via that penetrates an insulating layer (not shown) in the up-down direction Z.

As shown in FIG. 2, the second connection pad P2 includes the front side (−Y side) end portion of the first crossing line 22c1, a first intermediate pad 72a, a second intermediate pad 72b, a third intermediate pad 72c, and the first ground conductor 31. The front side (−Y side) end portion of the first crossing line 22c1, the first intermediate pad 72a, the second intermediate pad 72b, the third intermediate pad 72c, and the first ground conductor 31 overlap each other in plan view. Further, the front side (−Y side) end portion of the first crossing line 22c1, the first intermediate pad 72a, the second intermediate pad 72b, the third intermediate pad 72c, and the first ground conductor 31 are arranged in this order from the upper side (+Z side) to the lower side (−Z side), and are disposed with spacings therebetween in the up-down direction Z.

As shown in FIG. 2, the front side (−Y side) end portion of the first crossing line 22c1 and the first intermediate pad 72a are electrically and mechanically connected to each other through the plurality of connection conductors 50. Further, the first intermediate pad 72a and the second intermediate pad 72b are electrically and mechanically connected to each other through the plurality of connection conductors 50. Further, the second intermediate pad 72b and the third intermediate pad 72c are electrically and mechanically connected to each other through the plurality of connection conductors 50. Further, the third intermediate pad 72c and the first ground conductor 31 are electrically and mechanically connected to each other through the plurality of connection conductors 50. As a result, the second connection pad P2 electrically connects one end (−X side) of the second parallel line 22p2 to the first ground conductor 31 at all times.

As shown in FIG. 3, the third connection pad P3 includes the upper pad 21d2, the first intermediate pad 73a, the second intermediate pad 73b, the third intermediate pad 73c, and a lower pad 33a. The upper pad 21d2, the first intermediate pad 73a, the second intermediate pad 73b, the third intermediate pad 73c, and the lower pad 33a overlap each other in plan view. Further, the upper pad 21d2, the first intermediate pad 73a, the second intermediate pad 73b, the third intermediate pad 73c, and the lower pad 33a are arranged in this order from the upper side (+Z side) to the lower side (−Z side), and are disposed with spacings therebetween in the up-down direction Z.

Here, as shown in FIG. 1, the lower pad 33a is a rectangular flat plate conductor in which long sides extend in the crossing direction Y and short sides extend in the longitudinal direction X. The lower pad 33a is provided separately from the second ground conductor 32. The presence or absence of electrical connection between the lower pad 33a and the second ground conductor 32 is switched depending on a state of the first electronic switch 41 (described later). Accordingly, the presence or absence of the electrical grounding of the lower pad 33a is switched depending on the state of the first electronic switch 41.

As shown in FIG. 3, the upper pad 21d2 and the first intermediate pad 73a are electrically and mechanically connected to each other through the plurality of connection conductors 50. Further, the first intermediate pad 73a and the second intermediate pad 73b are electrically and mechanically connected to each other through the plurality of connection conductors 50. Further, the second intermediate pad 73b and the third intermediate pad 73c are electrically and mechanically connected to each other through the plurality of connection conductors 50. Further, the third intermediate pad 73c and the lower pad 33a are electrically and mechanically connected to each other through the plurality of connection conductors 50. As a result, the third connection pad P3 electrically connects the other end (+X side) of the first parallel line 21p1 to the first electronic switch 41 at all times.

As shown in FIG. 3, the fourth connection pad P4 includes the upper pad 22d, a first intermediate pad 74a, a second intermediate pad 74b, a third intermediate pad 74c, and a lower pad 33b. The upper pad 22d, the first intermediate pad 74a, the second intermediate pad 74b, the third intermediate pad 74c, and the lower pad 33b overlap each other in plan view. Further, the upper pad 22d, the first intermediate pad 74a, the second intermediate pad 74b, the third intermediate pad 74c, and the lower pad 33b are arranged in this order from the upper side (+Z side) to the lower side (−Z side), and are disposed with spacings therebetween in the up-down direction 7.

Here, as shown in FIG. 1, the lower pad 33b is a rectangular flat plate conductor in which long sides extend in the crossing direction Y and short sides extend in the longitudinal direction X. The lower pad 33b is provided separately from the second ground conductor 32 and the lower pad 33a. The presence or absence of electrical connection between the lower pad 33b and the second ground conductor 32 is switched depending on a state of the second electronic switch 42 (described later). Accordingly, the presence or absence of the electrical grounding of the lower pad 33b is switched depending on the state of the second electronic switch 42.

As shown in FIG. 3, the upper pad 22d and the first intermediate pad 74a are electrically and mechanically connected to each other through the plurality of connection conductors 50. Further, the first intermediate pad 74a and the second intermediate pad 74b are electrically and mechanically connected to each other through the plurality of connection conductors 50. Further, the second intermediate pad 74b and the third intermediate pad 74c are electrically and mechanically connected to each other through the plurality of connection conductors 50. Further, the third intermediate pad 74c and the lower ped 33b are electrically and mechanically connected to each other through the plurality of connection conductors 50. As a result, the fourth connection pad P4 electrically connects the other end (+X side) of the second parallel line 22p2 to the second electronic switch 42 at all times.

Here, as shown in FIG. 3, a dimension D12 of the lower pad 33a forming a part of the connection pad P3 in the crossing direction Y is larger than a dimension D11 of the upper pad 21d2 forming a part of the connection pad P3 in the crossing direction Y, Further, a dimension D22 of the lower pad 33b forming a part of the connection pad P4 in the crossing direction Y is larger than a dimension D21 of the upper pad 22d forming a part of the connection pad P4 in the crossing direction Y. Although details will be described later, this configuration is due to the increase in sizes of the first electronic switch 41 and the second electronic switch 42 that are connected to the lower pads 33a and 33b in order to reduce the loss of the high-frequency signal.

For example, as shown in FIG. 2. the capacitor 60 is parallel flat plates of which an upper electrode is connected to the signal line 10 and a lower electrode is connected to the first ground conductor 31 through the third electronic switch 43. The capacitor 60 has a capacitance Ca corresponding to the facing area of the parallel flat plates. That is, the capacitance Ca is a circuit constant provided between the signal line 10 and the first ground conductor 31. However, the capacitor 60 may be a comb-tooth type capacitor.

As shown in FIG. 1, the first electronic switch 41 is a transistor that switchably connects the lower pad 33a of the third connection pad P3 to the second ground conductor 32. As shown in FIG. 1, the first electronic switch 41 of the present embodiment is, for example, a MOS type FET, in which a drain terminal is connected to the lower pad 33a of the third connection pad P3, a source terminal is connected to the second ground conductor 32, and a gate terminal is connected to a switch control unit 80.

The first electronic switch 41 switches the conduction state between the drain terminal and the source terminal between the open state and the closed state based on a gate signal input to the gate terminal from the switch control unit 80. That is, the switch control unit 80 causes the first electronic switch 41 to switch between the conducting state and the cut-off state between the other end (+X side) of the first parallel line 21p1 and the second ground conductor 32.

As shown in FIG. 1, the second electronic switch 42 is a transistor that switchably connects the lower pad 33b of the fourth connection pad P4 to the second ground conductor 32. As shown in FIG. 1, the second electronic switch 42 of the present embodiment is, for example, a MOS type FET, in which a drain terminal is connected to the lower pad 33b of the fourth connection pad P4, a source terminal is connected to the second ground conductor 32, and a gate terminal is connected to the switch control unit 80.

The second electronic switch 42 switches the conduction state between the drain terminal and the source terminal between the open state and the closed state based on a gate signal input to the gate terminal from the switch control unit 80. That is, the switch control unit 80 causes the second electronic switch 42 to switch between the conducting state and the cut-off state between the other end (+X side) of the second parallel line 22p2 and the second ground conductor 32.

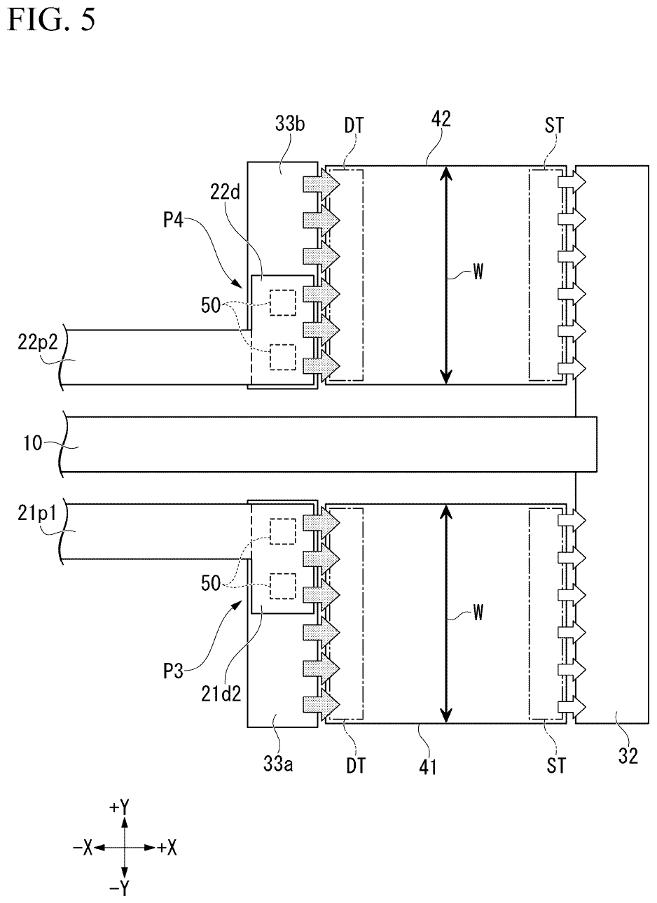

FIG. 5 is a plan view showing a connection relationship between the connection pads and the first and second electronic switches in the digital phase shift circuit according to the first embodiment of the present disclosure. As shown in FIG. 5, the first electronic switch 41 and the second electronic switch 42 are, for example, MOS type FETs having a rectangular shape in plan view, and each include a drain terminal DT and a source terminal ST. In FIG. 5, gate terminals are not shown,

As described above, the first electronic switch 41 and the second electronic switch 42 have a large size (specifically, a gate width W) in order to reduce the loss of the high-frequency signal. In a case where the sizes of the first electronic switch 41 and the second electronic switch 42 are increased, the lengths of the drain terminal DT and the source terminal ST in the Y direction are also increased as shown in FIG. 5.

In a case where the dimension D12 (see FIG. 3) of the lower pad 33a in the crossing direction Y is about the same as the dimension D11 of the upper pad 21d2 in the crossing direction Y, only a part of the drain terminal DT of the first electronic switch 41 is connected to the lower pad 33a. Similarly, in a case where the dimension D22 (see FIG. 3) of the lower pad 33b in the crossing direction Y is about the same as the dimension D21 of the upper pad 22d in the crossing direction Y, only a part of the drain terminal DT of the second electronic switch 42 is connected to the lower pad 33b.

In the present embodiment, the dimension D12 of the lower pad 33a in the crossing direction Y is set to be longer in accordance with the length of the drain terminal DT of the first electronic switch 41 in the Y direction. That is, the dimension D12 of the lower pad 33a in the crossing direction Y is set to be larger than the dimension D11 of the upper pad 21d2 in the crossing direction Y. As a result, the entire drain terminal DT of the first electronic switch 41 is connected to the lower pad 33a.

Similarly, the dimension D22 of the lower pad 33b in the crossing direction Y is set to be longer in accordance with the length of the drain terminal DT of the second electronic switch 42 in the Y direction, That is, the dimension D22 of the lower pad 33b in the crossing direction Y is set to be larger than the dimension D21 of the upper pad 22d in the crossing direction Y. As a result, the entire drain terminal DT of the second electronic switch 42 is connected to the lower pad 33b.

The other short side (−Y side) of the second ground conductor 32 is located at substantially the same position, in the crossing direction Y, as the other short side (−Y side) of the lower pad 33a. That is, the second ground conductor 32 extends from one short side (+Y side) of the lower pad 33b to the other short side (−Y side) of the lower pad 33a in the Y direction. Therefore, as shown in FIG. 5, the entire source terminals ST of the first electronic switch 41 and the second electronic switch 42 are also connected to the second ground conductor 32.

As shown in FIG. 2, the third electronic switch 43 is a transistor that switchably connects the lower electrode of the capacitor 60 to the first ground conductor 31. The third electronic switch 43 is, for example, a MOS type FET, in which a drain terminal is connected to the lower electrode of the capacitor 60, a source terminal is connected to the first ground conductor 31, and a gate terminal is connected to the switch control unit 80.

Here, as shown in FIG. 2, the third electronic switch 43 is disposed at a position away from the signal line 10 toward the rear side (+Y side). In addition, one end (+Y side) of the first ground conductor 31 extends away from the signal line 10 in the crossing direction Y and is connected to the third electronic switch 43. The reason for such a disposition is that there is a design rule constraint for the connection of the lower electrode of the capacitor 60 in a specific semiconductor manufacturing process.

Specifically, there is a restriction that the lower electrode of the capacitor 60 is first connected to an upper wiring layer (for example, a layer in which the signal line 10 is formed) through a connection wiring line and a via, and then connected to a lower wiring layer through a via from the upper wiring layer. In FIG. 2, a connection path between the lower electrode of the capacitor 60 and the third electronic switch 43 is shown in a simplified manner. Due to this restriction, the third electronic switch 43 cannot be disposed in the vicinity of the position (for example, the input end side (−X side) of the signal line 10 shown in FIG. 1) at which the capacitor 60 is formed, and needs to be disposed at a position away from the signal line 10 toward the rear side (+Y side). The first ground conductor 31 is connected to the source terminal of the third electronic switch 43 disposed at such a position, and thus extends away from the signal line 10 in the crossing direction Y.

The third electronic switch 43 switches the conduction state between the drain terminal and the source terminal between the open state and the closed state based on a gate signal input to the gate terminal from the switch control unit 80. That is, the switch control unit 80 causes the third electronic switch 43 to switch between the conducting state and the cut-off state between the lower electrode of the capacitor 60 and the first ground conductor 31.

Here, the sizes (gate widths) of the first electronic switch 41 and the second electronic switch 42 are set to, for example, twice or more a size (gate width) of the third electronic switch 43. It is preferable that the sizes (gate widths) of the first electronic switch 41 and the second electronic switch 42 are 5 times or more the size (gate width) of the third electronic switch 43.

Although details will be described later, in the present embodiment, the loss of the high-frequency signal in the high-delay mode can be significantly reduced. Since it is desirable that the difference between the loss of the high-frequency signal in the high-delay mode and the loss of the high-frequency signal in the low-delay mode is as small as possible, when the loss of the high-frequency signal in the high-delay mode is reduced, it is also necessary to reduce the loss of the high-frequency signal in the low-delay mode. Therefore, the sizes of the first electronic switch 41 and the second electronic switch 42 are set to be larger than the size of the third electronic switch 43.

In order to reduce the difference between the loss of the high-frequency signal in the high-delay mode and the loss of the high-frequency signal in the low-delay mode, it is necessary to set the sizes of 1 electronic switch 41 and the second electronic switch 42 to be twice or more the size of the third electronic switch 43. Further, in a case where the sizes of the first electronic switch 41 and the second electronic switch 42 are set to be 5 times or more the size of the third electronic switch 43, the loss of the high-frequency signal in the high-delay mode and the loss of the high-frequency signal in the low-delay mode can be set to be about the same.

As shown in FIG. 2, the fourth electronic switch 44 is a transistor that switchably connects the input end side (−X side) of the signal line 10 to the first ground conductor 31. Similar to the first electronic switch 41, the second electronic switch 42, and the third electronic switch 43, this fourth electronic switch 44 is an MOS type FET, in which a drain terminal is connected to the input end side (−X side) of the signal line 10, a source terminal is connected to the first ground conductor 31, and a gate terminal is connected to the switch control unit 80. Further, the fourth electronic switch 44 may not be provided between the Input end side (−X side) of the signal line 10 and the first ground conductor 31 but may be provided between the output end side (+X side) of the signal line 10 and the second ground conductor 32.

The fourth electronic switch 44 switches the conduction state between the drain terminal and the source terminal between the open state and the closed state based on a gate signal input to the gate terminal from the switch control unit 80. That is, the switch control unit 80 causes the fourth electronic switch 44 to switch between the conducting state and the cut-off state between the input end side (−X side) of the signal line 10 and the first ground conductor 31.

The switch control unit 80 is a control circuit that controls the first electronic switch 41, the second electronic switch 42, the third electronic switch 43, and the fourth electronic switch 44, The switch control unit 80 includes four output ports, and individually outputs the gate signals from each output port to the gate terminals of the first electronic switch 41, the second electronic switch 42, the third electronic switch 43. and the fourth electronic switch 44. That is, the switch control unit 80 opens or closes the first electronic switch 41, the second electronic switch 42, the third electronic switch 43, and the fourth electronic switch 44 using the gate signals.

Next, the operations of the digital phase shift circuit B configured as described above will be described.

In the digital phase shift circuit B of the present embodiment, the operation mode is switched depending on the conduction states of the first to third electronic switches 41 to 43. That is, the operation mode of the digital phase shift circuit B includes a low-delay mode in which the switch control unit 80 sets the first electronic switch 41 and the second electronic switch 42 to the closed state, and sets the third electronic switch 43 to the open state, and a high-delay mode in which the switch control unit 80 sets the first electronic switch 41 and the second electronic switch 42 to the open state, and sets the third electronic switch 43 to the closed state.

In the low-delay mode, the switch control unit 80 sets the first electronic switch 41 and the second electronic switch 42 to the closed state, and sets the third electronic switch 43 to the open state. That is, in the low-delay mode, the phase at the output end (right end) becomes a first phase θ_{L} smaller than a second phase θ_{H} in the high-delay mode, by a first propagation delay time T_{L} until the high-frequency signal propagates from the input end (left end) to the output end (right end) of the signal line 10. Hereinafter, the low-delay mode will be described in more detail.

By setting the first electronic switch 41 to the closed state, the other end (+X side) of the first parallel line 21p1 is connected to the second ground conductor 32 through the third connection pad P3 (see FIG. 1). On the other hand, one end (−X side) of the first parallel line 21p1 is connected to the first ground conductor 31 at all times through the first connection pad P1 (see FIGS. 1 and 2). Therefore, the first parallel line 21p1 forms a first conduction path through which the current can flow between one end (−X side) and the other end (+X side) of the first parallel line 21p1 by connecting the other end (+X side) to the second ground conductor 32 through the first electronic switch 41.

In addition, by setting the second electronic switch 42 to the closed state, the other end (+X side) of the second parallel line 22p2 is connected to the second ground conductor 32 through the fourth connection pad P4 (see FIG. 1). On the other hand, one end (−X side) of the second parallel line 22p2 is connected to the first ground conductor 31 at all times through the second connection pad P2 (see FIGS. 1 and 2). Therefore, the second parallel line 22p2 forms a second conduction path through which the current can flow between one end (−X side) and the other end (+X side) of the second parallel line 22p2 by connecting the other end (+X side) to the second ground conductor 32 through the second electronic switch 42.

In a state where both ends of the first parallel line 21p1 and the second parallel line 22p2 are connected to each other, when a signal current flows from the input end toward the output end in the signal line 10, a return current is generated in the first parallel line 21p1 and the second parallel line 22p2 due to the propagation of the signal current. The return current flows through the first parallel line 21p1 and the second parallel line 22p2 from the other end (+X side) to one end (−X side).

That is, due to the energization of the signal current in the signal line 10, a first return current flows in the first parallel line 21p1 forming the first conduction path in an opposite direction to the energization direction of the signal current. Further, due to the energization of the signal current in the signal line 10, a second return current flows in the second parallel line 22p2 forming the second conduction path in an opposite direction to the energization direction of the signal current, that is, the same direction as the first return current.

Here, both the first return current flowing through the first parallel line 21p1 and the second return current flowing through the second parallel line 22p2 flow in an opposite direction to the energization direction of the signal current. Accordingly, the first return current and the second return current act to reduce the entire inductance of the digital phase shift circuit B due to electromagnetic coupling (mutual induction) between the signal line 10 and the first parallel line 21p1 and electromagnetic coupling (mutual induction) between the signal line 10 and the second parallel line 22p2. An inductance of the signal line 10 is denoted by Ls_{low}, an inductance of the return path (first parallel line 21p1 and second parallel line 22p2) is denoted by Lg_{low}, and a mutual inductance between the signal line 10 and the return path is denoted by M_{low}. The entire inductance L_{low} of the digital phase shift circuit B in the low-delay mode is Ls_{low}+Lg_{low}~M_{low}.

Further, the signal line 10 has the capacitance CI as the parasitic capacitance as described above. In the low-delay mode, since the third electronic switch 43 is set to the open state, the capacitor 60 is not connected between the signal line 10 and the first ground conductor 31. That is, the capacitance Ca of the capacitor 60 does not affect the high-frequency signal that propagates through the signal line 10. Accordingly, the first propagation delay time T_{L} proportional to (L_{low}×C1)^{1/2} acts on the high-frequency signal that propagates through the signal line 10.

The high-frequency signal at the output end of the signal line 10 has a phase delayed by the first phase θ_{L} with respect to the high-frequency signal at the input end of the signal line 10 due to such a first propagation delay time T_{L}. That is, in the low-delay mode, the entire inductance of the digital phase shift circuit B becomes the inductance L_{low} due to the first return current and the second return current, so that the propagation delay time is reduced.

On the other hand, in the high-delay mode, the switch control unit 80 sets the first electronic switch 41 and the second electronic switch 42 to the open state, and sets the third electronic switch 43 to the closed state. Further, the fourth electronic switch 44 is set to the open state. That is, in the high-delay mode, the phase at the output end (right end) becomes the second phase θ_{H} that is larger than the first phase θ_{L} in the low-delay mode due to a second propagation delay time T_{H} until the high-frequency signal propagates from the input end (left end) to the output end (right end) of the signal line 10. Hereinafter, the high-delay mode will be described in more detail.

As described above, in the high-delay mode, the first electronic switch 41 and the second electronic switch 42 are set to the open state. Therefore, the first conductive path described above is not formed in the first parallel line 21p1, and the second conductive path described above is not formed in the second parallel line 22p2. Therefore, the first return current that flows through the first parallel line 21p1 becomes extremely small, and the second return current that flows through the second parallel line 22p2 becomes extremely small.

On the other hand, the front side (−Y side) end portion of the first crossing line 22c1 is connected to the first ground conductor 31 through the second connection pad P2 at all times (see FIG. 2). In addition, as described above, one end (−Y side) of the second crossing line 22c2 is connected to the second ground conductor 32 at all times. Therefore, a third conduction path through which a current can flow is formed in the loop line 22L in advance between one end (−Y side) of the second crossing line 22c2 and the front side (−Y side) end portion of the first crossing line 22c1. Therefore, in the high-delay mode, due to the signal current in the signal line 10, a third return current flows from one end (−Y side) of the second crossing line 22c2 in the first loop line section 22L1 toward the front side (−Y side) end portion of the first crossing line 22c1 in the first loop line section 22L1 through the via 23, the second loop line section 22L2, and the via 23.

Here, the loop line 22L through which the third return current flows is a line that is convex on the opposite side (+Y side) to the signal line 10. Therefore, the inductance of the return path can be increased as compared to the configuration in the related art in which the return path (a path through which the third return current flows) does not constitute a loop line. Accordingly, the entire inductance of the digital phase shift circuit B can be increased. The inductance of the signal line 10 is denoted by Ls_{high}, the inductance of the return path (loop line 22L) is denoted by Lg_{high}, and the mutual inductance between the signal line 10 and the return path is denoted by M_{high}. Here, Ls_{high}=Ls_{low}. The entire inductance Ligy of the digital phase shift circuit B in the high-delay mode is Ls_{high}+Lg_{high}−M_{high}. Here, it is clear that Lg_{low}<Lg_{high} and M_{low}>M_{high} are satisfied, so that L_{high}>L_{low} is satisfied.

The principle in which the third return current acts to increase the inductance of the return path can be described as follows. That is, the magnetic fields generated in the loop line 22L by the third return current flowing through each portion of the loop line 22L have the same direction (+Z direction). Therefore, these magnetic fields strengthen each other. Therefore, it is possible to increase the magnetic field generated by the third return current and to increase the inductance of the return path as compared to the configuration in the related art in which the line through which the third return current flows does not constitute the loop line.

In addition, in the present embodiment, the loop line 22L has a three-dimensional structure in which the first loop line section 22L1 and the second loop line section 22L2 formed in different layers are connected to each other through the via 23 (see FIG. 4). Since the via 23 itself has the inductance, the inductance of the return path can be further increased by causing the loop line 22L to have the three-dimensional structure. In addition, the portions (third parallel line 22p3 and third crossing line 22c3) of the second loop line section 22L2 other than the via pads VP21 and VP22 are narrowed-width line sections having a smaller width than the widths of the via pads VP21 and VP22. This configuration also increases the inductance of the return path. In addition, by adjusting the height of the loop (that is, the position of the third parallel line 22p3 in the crossing direction Y, and the first crossing line 22c1 and the second crossing line 22c2), the value of the inductance of the return path can also be significantly changed.

Meanwhile, the signal line 10 has the capacitance C1 as the parasitic capacitance. Further, in the high-delay mode, since the third electronic switch 43 is set to the closed state, the capacitor 60 is connected between the signal line 10 and the first ground conductor 31. That is, the signal line 10 has a capacitance Cb obtained by adding the capacitance Ca of the capacitor 60 and the capacitance C1 (parasitic capacitance). Therefore, the second propagation delay time T_{H}, which is associated with the increase in the inductance of the transmission system and the total capacitance Cb, acts on the high-frequency signal propagating through the signal line 10.

The high-frequency signal at the output end of the signal line 10 has a phase delayed by the second phase θ_{H} with respect to the high-frequency signal at the input end of the signal line 10 due to such a second propagation delay time T_{H}. That is, in the high-delay mode, the propagation delay time is increased by increasing the inductance of the transmission system due to the third return current.

Here, in the high-delay mode, the loss of the signal line 10 may be intentionally increased by setting the electronic switch 44 to the closed state. The loss is applied for making the loss of the high-frequency signal in the high-delay mode be about the same as the loss of the high-frequency signal in the low-delay mode.

### Digital Phase Shifter

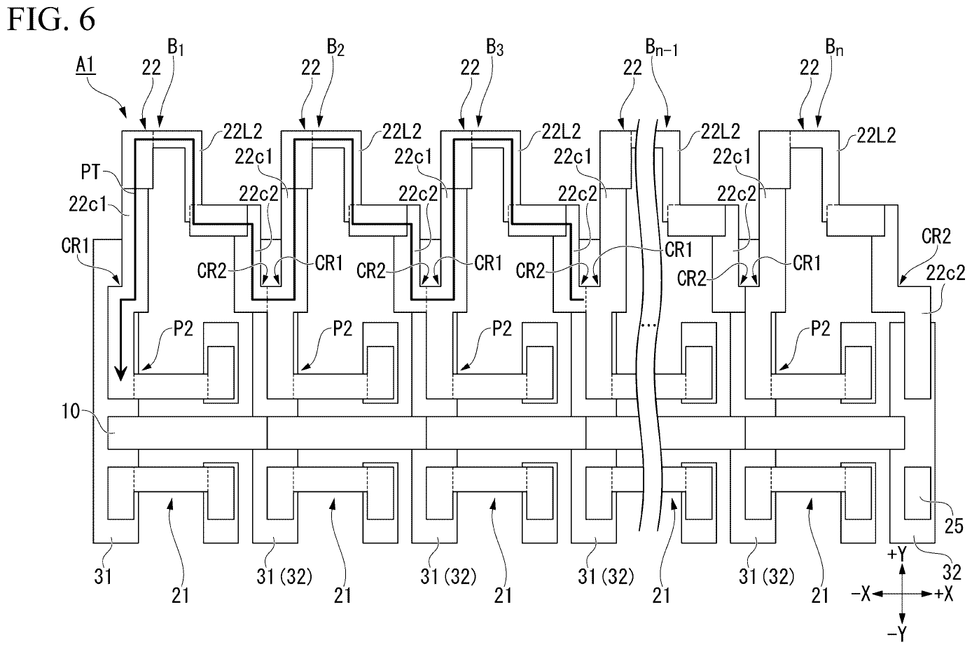

FIG. 6 is a plan view showing a configuration of main parts of the digital phase shifter according to the first embodiment of the present disclosure. As shown in FIG. 6, a digital phase shifter A1 of the present embodiment is configured by cascade-connecting a plurality of digital phase shift circuits B₁, B₂, B₃, . . . , Bₙ₋₁, and Bₙ in the longitudinal direction X. The basic configurations of the digital phase shift circuits B₁, B₂, B₃, . . . , Bₙ₋₁, and Bₙ are the same as that of the digital phase shift circuit B described with reference to FIGS. 1 to 5.

The digital phase shifter A1 outputs, from the digital phase shift circuit Bₙ, the high-frequency signal input from the digital phase shift circuit B₁ or outputs, from the digital phase shift circuit B₁, the high-frequency signal input from the digital phase shift circuit Bₙ. Hereinafter, as an example, a case will be described in which the high-frequency signal input from the digital phase shift circuit B₁ is output from the digital phase shift circuit Bₙ. In FIG. 6, for ease of viewing, the first electronic switch 41, the second electronic switch 42, and the switch control unit 80 are omitted.

As shown in FIG. 6, the digital phase shifter A1 is cascade-connected in the longitudinal direction X such that the first line 21 is located only on the other side (−Y side) of the signal line 10 and the second line 22 is located only on one side (+Y side) of the signal line 10. That is, the digital phase shifter A1 has a configuration in which the loop line is disposed only on one side (+Y side) of the signal line 10. Such a configuration is adopted in order to reduce the size of the digital phase shifter A1.

In the digital phase shifter A1 according to the present embodiment, the digital phase shift circuits Bₙ to Bₙ₋₁ are connected to the digital phase shift circuits B₂ to Bₙ adjacent to the right side (+X side) thereof such that a part of each of the digital phase shift circuits B₁ to Bₙ₋₁ enters each of the digital phase shift circuits B₂ to Bₙ. In the digital phase shifter A1 according to the embodiment, the digital phase shift circuits B₂ to Bₙ can also be described to be connected to the digital phase shift circuits B₁ to Bₙ₋₁ adjacent to the left side (−X side) thereof such that a part of each of the digital phase shift circuits B₂ to Bₙ enters each of the digital phase shift circuits B₁ to Bₙ₋₁.

More specifically, in a portion in which the digital phase shift circuits are adjacent to each other, the first ground conductor 31 and the second ground conductor 32 are integrated, a part of the first crossing line 22c1 and a part of the second crossing line 22c2 are integrated, and the upper pad 21d1 and the upper pad 25 are integrated. In the example shown in FIG. 6, for example, the second ground conductor 32 of the digital phase shift circuit B₁ and the first ground conductor 31 of the digital phase shift circuit B₂ are integrated, a part of the second crossing line 22c2 of the digital phase shift circuit B₁ and a part of the first crossing line 22c1 of the digital phase shift circuit B₂ are integrated, and the upper pad 25 of the digital phase shift circuit B₁ and the upper pad 21d1 of the digital phase shift circuit B₂ are integrated.

Therefore, the first ground conductor 31 of the digital phase shift circuit B₂ also functions as the second ground conductor 32 of the digital phase shift circuit B₁. Further, a part of the first crossing line 22c1 of the digital phase shift circuit B₂ also functions as a part of the second crossing line 22c2 of the digital phase shift circuit B₁. Further, the upper pad 21d1 of the digital phase shift circuit B₂ also functions as the upper pad 25 of the digital phase shift circuit B₁.

Here, the bent portion CR1 is formed in the first crossing line 22c1, and a side of the first crossing line 22c1 close to the second parallel line 22p2 has a crank shape. In addition, the bent portion CR2 is formed in the second crossing line 22c2, and a side of the second crossing line 22c2 close to the second parallel line 22p2 has a crank shape. Therefore, in the portion in which the digital phase shift circuits B are adjacent to each other, the first crossing line 22c1 and the second crossing line 22c2 that are integrated have a T-shape, in plan view, extending from one end (−X side) of the second parallel line 22p2 to be away from the signal line 10 in the crossing direction Y, being bent to the right side (+X side) at the bent portion CR1, and being bent to the left side (−X side) at the bent portion CR2.

By performing such a connection, it is possible to reduce the decrease in magnetic field caused by interference between the adjacent digital phase shift circuits B. As a result, the mutual inductance between the adjacent digital phase shift circuits B can be reduced.

In this way, in the digital phase shifter A1 of the present embodiment, as described above, in each of the digital phase shift circuits B₁ to Bₙ, the line through which the third return current flows constitutes the loop line 22L that is convex toward a side (+Y side) opposite to the signal line 10. In addition, the loop line 22L has a three-dimensional structure through the via 23, and the second loop line section 22L2 constituting the loop line 22L includes the third parallel line 22p3 and the third crossing line 22c3 that are narrowed width line sections having a smaller width than other portions of the second loop line section 22L2. Therefore, the generation efficiency of the magnetic field can be significantly increased as compared to the related art. Further, in the digital phase shifter A1 of the present embodiment, as described above, the mutual inductance between the adjacent digital phase shift circuits B can be reduced. Accordingly, even in a configuration in which the loop line is disposed only on one side (+Y side) of the signal line 10, the digital phase shifter A1 of the present embodiment can ensure the required phase shift amount.

In the digital phase shifter A1 of the present embodiment, for example, except for the digital phase shift circuit B₁, in a case where the adjacent digital phase shift circuits are set to the high-delay mode, the third return current flows through a path that does not pass through the second connection pad P2. For example, in a case where the digital phase shift circuits B₁ to B₃ are set to the high-delay mode, the third return current flows through a path PT in the drawing without passing through an obstacle having a large loss, such as the second connection pad P2, the first ground conductor 31 (the second ground conductor 32), and the like of the digital phase shift circuits B₂ and B₃. Therefore, the digital phase shifter A1 of the present embodiment can significantly reduce the loss of the high-frequency signal in the high-delay mode.

In this way, the digital phase shifter A1 of the present embodiment can significantly reduce the loss of the high-frequency signal in the high-delay mode. As a result, the sizes of the first electronic switch 41 and the second electronic switch 42 disposed on the current paths of the first return current and the second return current in the low-delay mode can be increased. This is because it is desirable that the difference between the loss of the high-frequency signal in the high-delay mode and the loss of the high-frequency signal in the low-delay mode is as small as possible, and thus, when the loss of the high-frequency signal in the high-delay mode is reduced, it is also necessary to reduce the loss of the high-frequency signal in the low-delay mode. In this manner, the digital phase shifter A1 of the present embodiment can reduce the loss of the high-frequency signal as a whole.

As described above, the digital phase shifter A1 of the present embodiment is a phase shifter including the plurality of digital phase shift circuits B₁ to Bₙ that are cascade-connected. Each of the plurality of digital phase shift circuits B₁ to Bₙ includes the signal line 10, the first line 21, the second line 22, the first ground conductor 31, the second ground conductor 32, the first electronic switch 41, and the second electronic switch 42. The first line 21 includes the first parallel line 21p1 that extends parallel to the signal line 10. The second line 22 includes the second parallel line 22p2 that extends parallel to the signal line 10, and the loop line 22L that extends from one end portion of the second parallel line 22p2 to the vicinity of the other end portion of the second parallel line 22p2 in plan view and that is convex toward a direction away from the signal line 10 in the crossing direction crossing the longitudinal direction of the signal line 10.

In addition, each of the plurality of digital phase shift circuits B₁ to Bₙ includes the first ground conductor 31, the second ground conductor 32, the first electronic switch 41, and the second electronic switch 42. The first ground conductor 31 is electrically connected to one end portion of the first parallel line 21p1 and one end portion of the second parallel line 22p2, and the second ground conductor 32 is connected to one end portion of the second line 22. The first electronic switch 41 is provided between the other end portion of the first parallel line 21p1 and the second ground conductor 32, and the second electronic switch 42 is provided between the other end portion of the second parallel line 22p2 and the second ground conductor 32.

In addition, in each of the plurality of digital phase shift circuits B₁ to Bₙ, the signal line 10 is located between the first parallel line 21p1 and the second parallel line 22p2. The loop line 22L includes the first loop line section 22L1 formed in a first layer in which the signal line 10, the first parallel line 21p1, and the second parallel line 22p2 are formed, and the second loop line section 22L2 formed in a second layer different from the first layer through the via 23.

In the digital phase shifter A1 of the present embodiment, in the portion in which the digital phase shift circuits are adjacent to each other, the first ground conductor 31 and the second ground conductor 32 are integrated. In addition, in the portion in which the digital phase shift circuits are adjacent to each other, the second crossing line 22c2 is connected to the first crossing line 22c1 in the adjacent digital phase shift circuit. With the above-described configuration, it is possible to achieve desired phase shift characteristics with a smaller size than in the related art.

### Second Embodiment

### Digital Phase Shift Circuit

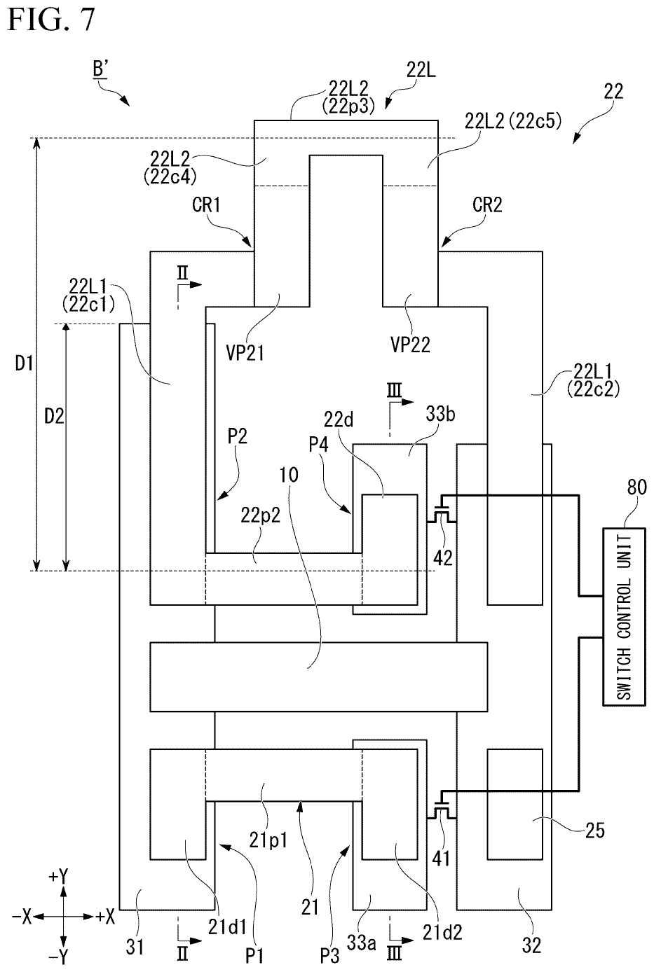

FIG. 7 is a plan view showing a basic configuration of a digital phase shift circuit according to a second embodiment of the present disclosure. In FIG. 7, the same components as those shown in FIG. I are denoted by the same reference numerals. As shown in FIG. 7, a digital phase shift circuit B′ according to the present embodiment has approximately the same configuration as the digital phase shift circuit B shown in FIG. 1, but has a different configuration of a loop line 22L. Specifically, the loop line 22L has a shape that is convex toward the rear side (+Y side) and is axisymmetric with respect to the X direction. The loop line 22L does not need to have a shape that is strictly axisymmetric with respect to the X direction, and may have a slightly different shape therefrom. That is, the loop line 22L may have a shape that is substantially axisymmetric (or a shape that is generally axisymmetric) with respect to the X direction.

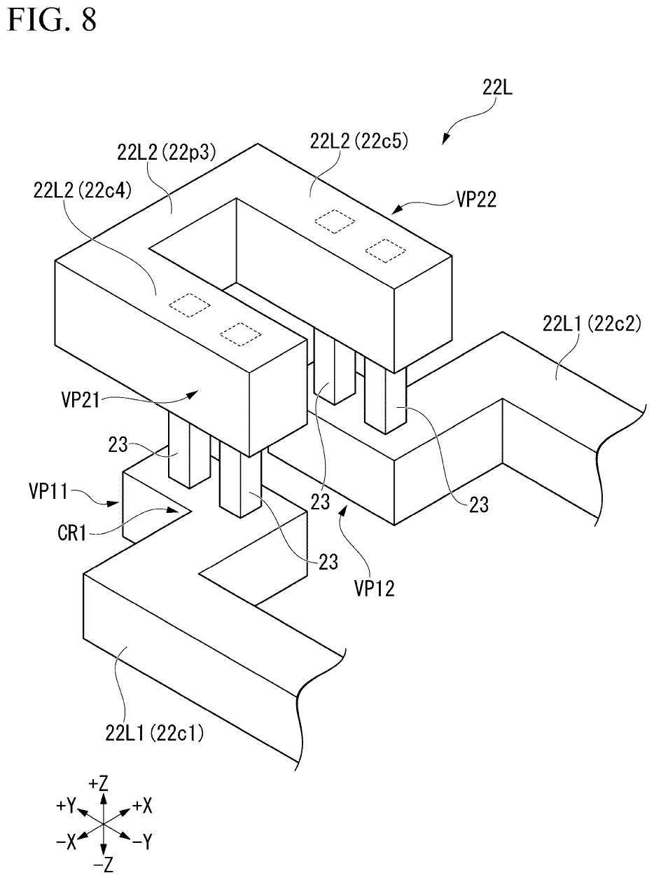

FIG. 8 is a perspective view showing a part of the loop line in the digital phase shift circuit according to the second embodiment of the present disclosure. As shown in FIGS. 7 and 8, the loop line 22L includes a first loop line section 22L1 having a shape that is axisymmetric with respect to the X direction and a second loop line section 22L2 having a shape that is axisymmetric with respect to the X direction.

The first crossing line 22c1 of the first loop line section 22L1 is a strip-shaped conductor in which a bent portion CRI is formed, similar to the first crossing line 22c1 in the first embodiment. However, in the first crossing line 22c1 of the present embodiment, the bent portion CR1 is provided on the rear side (+Y side) relative to the rear outer edge (outer edge on the third parallel line 22p3 side) of the first ground conductor 31. Further, the first crossing line 22c1 of the present embodiment has a constant width.

A rear end portion (+Y side) of the first crossing line 22c1 is a via pad VP11 to which a via 23 is connected (see FIG. 8). The via pad VP11 has a rectangular shape in which long sides extend in the crossing direction Y and short sides extend in the longitudinal direction X in plan view. The via pad VP11 is electrically connected to a via pad VP21 (described later in detail) at one end of the second loop line section 22L2 through the plurality of vias 23.

The second crossing line 22c2 of the first loop line section 22L1 is a strip-shaped conductor having a shape that is axisymmetric to the first crossing line 22c1 with respect to the X direction. Therefore, in the second crossing line 22c2, a bent portion CR2 is provided on the rear side (+Y side) relative to the rear outer edge (outer edge on the third parallel line 22p3 side) of the first ground conductor 31. Further, the second crossing line 22c2 has a constant width.

A rear end portion (+Y side) of the second crossing line 22c2 is a via pad VP12 to which the via 23 is connected (see FIG. 8). The via pad VP12 has a rectangular shape in which long sides extend in the crossing direction Y and short sides extend in the longitudinal direction X in plan view, The via pad VP12 is electrically connected to a via pad VP22 (described later in detail) at the other end of the second loop line section 22L2 through the plurality of vias 23.

The second loop line section 22L2 is a strip-shaped conductor including the third parallel line 22p3, a fourth crossing line 22c4, and a fifth crossing line 22c5, in which one end of the second loop line section 22L2 is the via pad VP21, and the other end of the second loop line section 22L2 is the via pad VP22. The third parallel line 22p3 is a conductor having a constant width, a constant thickness, and a predetermined length. The third parallel line 22p3 of the present embodiment extends from the left side edge (−X side) of the end portion on the rear side of the first crossing line 22c1 to the right side edge (+X side) on the end portion on the rear side of the second crossing line 22c2 in plan view.

The fourth crossing line 22c4 is a straight strip-shaped conductor that extends from one end (−X side) of the third parallel line 22p3 to approach the signal line 10 in the crossing direction Y, and has an end portion on the front side (−Y side) that is the via pad VP21 (see FIG. 8). The fifth crossing line 22c5 is a straight strip-shaped conductor that extends from the other end (+X side) of the third parallel line 22p3 to approach the signal line 10 in the crossing direction Y, and has an end portion on the front side (−Y side) that is the via pad VP22 (see FIG. 8). The third parallel line 22p3 has a narrower width than the fourth crossing line 22c4 and the fifth crossing line 22c5, and the fourth crossing line 22c4 and the fifth crossing line 22c5 have the same length. The width of the third parallel line 22p3 is narrower than the widths of the fourth crossing line 22c4 and the fifth crossing line 22c5 in order to increase the inductance of the return path, as in the first embodiment.

The via pad VP21 has a rectangular shape in which long sides extend in the crossing direction Y and short sides extend in the longitudinal direction X in plan view. The via pad VP21 is disposed to overlap the via pad VP11 in the up-down direction Z. The via pad VP21 and the via pad VP11 are electrically connected to each other through the plurality of vias 23. The via pad VP22 has a rectangular shape in which long sides extend in the crossing direction Y and short sides extend in the longitudinal direction X in plan view. The via pad VP22 is disposed to overlap the via pad VP12 in the up-down direction Z. The via pad VP22 and the via pad VP12 are electrically connected to each other through the plurality of vias 23.

In the via pads VP11, VP12, VP21, and VP22, the vias 23 are arranged along the long sides of each of the via pads VP11, VP12, VP21, and VP22. Specifically, the vias 23 are arranged in the crossing direction Y in the via pads VP11 and VP21 and the via pads VP12 and VP22. That is, the vias 23 at both ends of the second loop line section 22L2 are arranged such that arrangement directions of the vias 23 are parallel to each other.

In the present embodiment, as shown in FIGS. 7 and 8, the via pad VP11 and the via pad VP12 are connected by the second loop line section 22L2 having a U-shape. Further, the width of the third parallel line 22p3 is narrower than the widths of the fourth crossing line 22c4 and the fifth crossing line 22c5. As a result, the inductance of the return path can be increased, and desired phase shift characteristics can be achieved with a smaller size than in the related art.

The configuration of the digital phase shift circuit B′ other than the loop line 22L is the same as that of the digital phase shift circuit B of the first embodiment. Further, the operation of the digital phase shift circuit B′ is basically the same as that of the digital phase shift circuit B. Therefore, descriptions of the configuration of the digital phase shift circuit B′ other than the loop line 22L and the operation of the digital phase shift circuit B′ will be omitted.

### Digital Phase Shifter

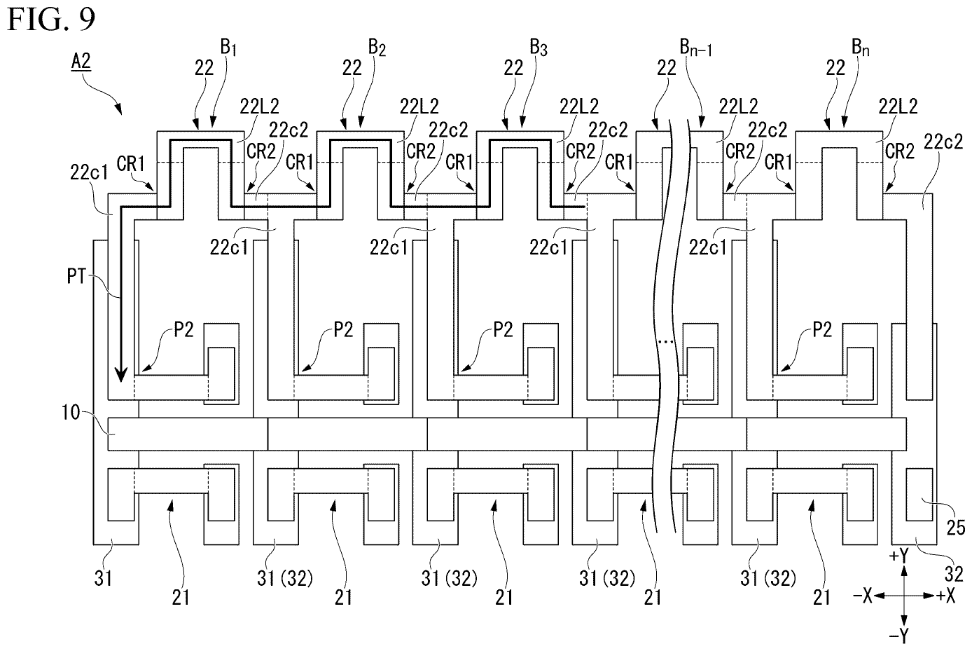

FIG. 9 is a plan view showing a configuration of main parts of the digital phase shifter according to the second embodiment of the present disclosure. As shown in FIG. 9, a digital phase shifter A2 of the present embodiment is obtained by cascade-connecting a plurality of digital phase shift circuits B₁, B₂, B₃, . . . , Bₙ₋₁, and Bₙ in the longitudinal direction X. The basic configurations of the digital phase shift circuits B₁, B₂, B₃, . . . , Bₙ₋₁, and Bₙ are the same as that of the digital phase shift circuit B′ described with reference to FIGS. 7 and 8. In FIG. 9, as in FIG. 6, the first electronic switch 41, the second electronic switch 42, and the switch control unit 80 are not shown.

In the digital phase shifter A2 shown in FIG. 9, in each of the digital phase shift circuits B₁ to Bₙ, the line through which the third return current flows constitutes the loop line 22L that is convex on the opposite side (+Y side) to the signal line 10, as in the digital phase shifter A1 shown in FIG. 6. In addition, the loop line 22L has a three-dimensional structure through the via 23. Therefore, the generation efficiency of the magnetic field can be significantly increased as compared to the related art. As a result, even when the digital phase shifter A2 of the present embodiment has the configuration in which the loop line is disposed only on one side (+Y side) of the signal line 10, as in the digital phase shifter A1 shown in FIG. 6, the required phase shift amount can be ensured.

Further, the digital phase shifter A2 shown in FIG. 9 is different from the digital phase shifter A1 shown in FIG. 6 only in the loop lines 22L that are provided in each of the digital phase shift circuits B₁, B₂, B₃, . . . , Bₙ₋₁, and Bₙ, and the configurations thereof other than the loop lines 22L are the same as those of the digital phase shifter A1 shown in FIG. 6. Therefore, in the digital phase shifter A2 of the present embodiment as well, for example, except for the digital phase shift circuit B₁, in a case where the adjacent digital phase shift circuits are set to the high-delay mode, the third return current flows through a path that does not pass through the second connection pad P2. For example, in a case where the digital phase shift circuits B₁ to B₃ are set to the high-delay mode, the third return current flows through a path PT in FIG. 9. Therefore, the digital phase shifter A2 of the present embodiment can significantly reduce the loss of the high-frequency signal in the high-delay mode, similarly to the digital phase shifter A1 shown in FIG. 6.

As a result, in the digital phase shifter A2 of the present embodiment as well, the sizes of the first electronic switch 41 and the second electronic switch 42 disposed in the current paths of the first return current and the second return current in the low-delay mode can be increased. This is because it is desirable that the difference between the loss of the high-frequency signal in the high-delay mode and the loss of the high-frequency signal in the low-delay mode is as small as possible, and thus, when the loss of the high-frequency signal in the high-delay mode is reduced, it is also necessary to reduce the loss of the high-frequency signal in the low-delay mode. In this manner, the digital phase shifter A2 of the present embodiment can also reduce the loss of the high-frequency signal as a whole.

As described above, the digital phase shifter A2 of the present embodiment is different from the digital phase shifter A1 shown in FIG. 6 only in the loop lines 22L that are provided in each of the digital phase shift circuits B₁, B₂, B₃, . . . , Bₙ₋₁, and Bₙ, and the configurations thereof other than the loop lines 22L are the same as those of the digital phase shifter A1 shown in FIG. 6. Therefore, in the digital phase shifter A2 of the present embodiment as well, it is possible to achieve desired phase shift characteristics with a smaller size than in the related art.

### Modification Example

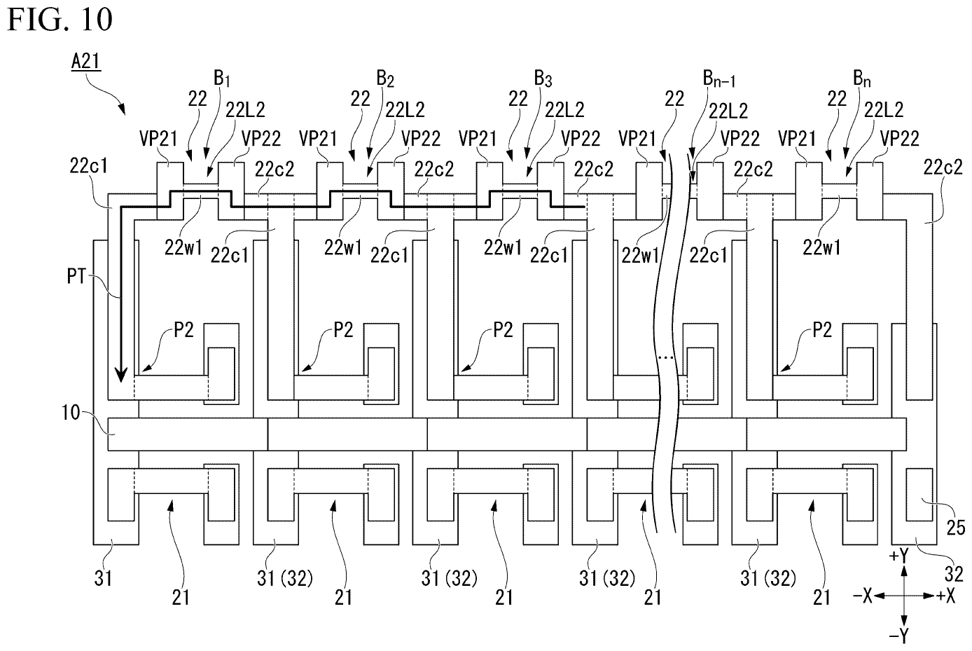

FIGS. 10 to 12 are plan views showing modification examples of the digital phase shifter according to the second embodiment of the present disclosure. Digital phase shifters A21 to A23 shown in FIGS. 10 to 12 are digital phase shifters in which the configurations of the loop lines 22L in each of the digital phase shift circuits B₁, B₂, B₃, . . . , Bₙ₋₁, and Bₙ are changed.

In the digital phase shifter A21 shown in FIG. 10, the second loop line section 22L2 of the loop line 22L in each of the digital phase shift circuits B₁, B₂, B₃, . . . , Bₙ₋₁, and Bₙ has the via pad VP21, the via pad VP22, and a straight wiring line 22w1 (narrowed-width line section). The digital phase shifter A21 according to the present modification example has a smaller phase shift amount than the digital phase shifter A1 shown in FIG. 6.

The straight wiring line 22w1 is a straight wiring line that extends in the longitudinal direction X and that connects the via pad VP21 to the via pad VP22. The straight wiring line 22w1 is a conductor having a constant width, a constant thickness, and a predetermined length. However, the width of the straight wiring line 22w1 is smaller than the widths of the via pads VP21 and VP22 or the first crossing line 22c1 and the second crossing line 22c2 of the first loop line section 22L1.

In the example shown in FIG. 10, the straight wiring line 22w1 connects a right end edge (+X side) of the via pad VP21 and a left end edge (−X side) of the via pad VP22 at a middle portion of the via pads VP21 and VP22 in the crossing direction Y. A configuration can also be adopted in which the straight wiring line 22w1 connects the right end edge (+X side) of the via pad VP21 to the left end edge (−X side) of the via pad VP22 at the rear end portion (+Y side) of the via pads VP21 and VP22. With such a configuration, the phase shift amount can be increased as compared to the digital phase shifter A21 having the configuration shown in FIG. 10.

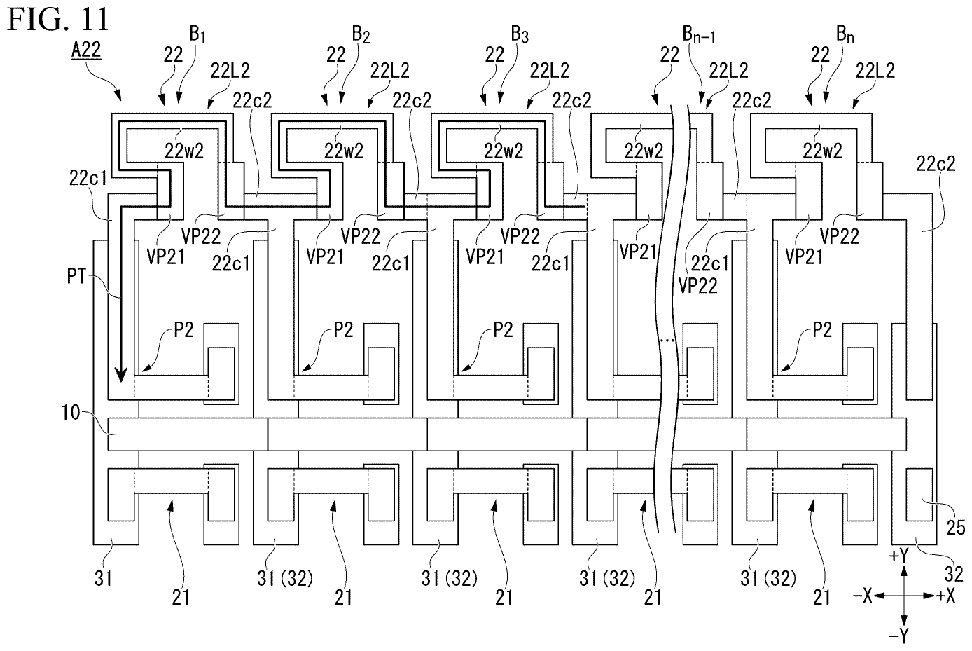

In the digital phase shifter A22 shown in FIG. 11, the second loop line section 22L2 of the loop line 22L in each of the digital phase shift circuits B₁, B₂, B₃, . . . , Bₙ₋₁, and Bₙ has the via pad VP21, the via pad VP22, and a loop wiring line 22w2 (narrowed-width line section). The digital phase shifter A22 according to the present modification example has a larger phase shift amount than the digital phase shifter A1 shown in FIG. 6.

The loop wiring line 22w2 shown in FIG. 11 consists of four straight sections (first straight section, second straight section, third straight section, and fourth straight section). The first straight section extends from the rear end portion of the via pad VP22 toward the rear side (+Y side). The second straight section extends from one end portion (+Y side) of the first straight section toward the left side (−X side). The third straight section extends from one end portion (−X side) of the second straight section toward the front side (−Y side), The fourth straight section extends from one end portion (−Y side) of the third straight section toward the right side (+X side) and is connected to the left end edge (−X side) on the rear side (+Y side) of the via pad VP21. However, the width of the loop wiring line 22w2 is smaller than the widths of the via pads VP21 and VP22 or the widths of the first crossing line 22c1 and the second crossing line 22c2 of the first loop line section 22L1.

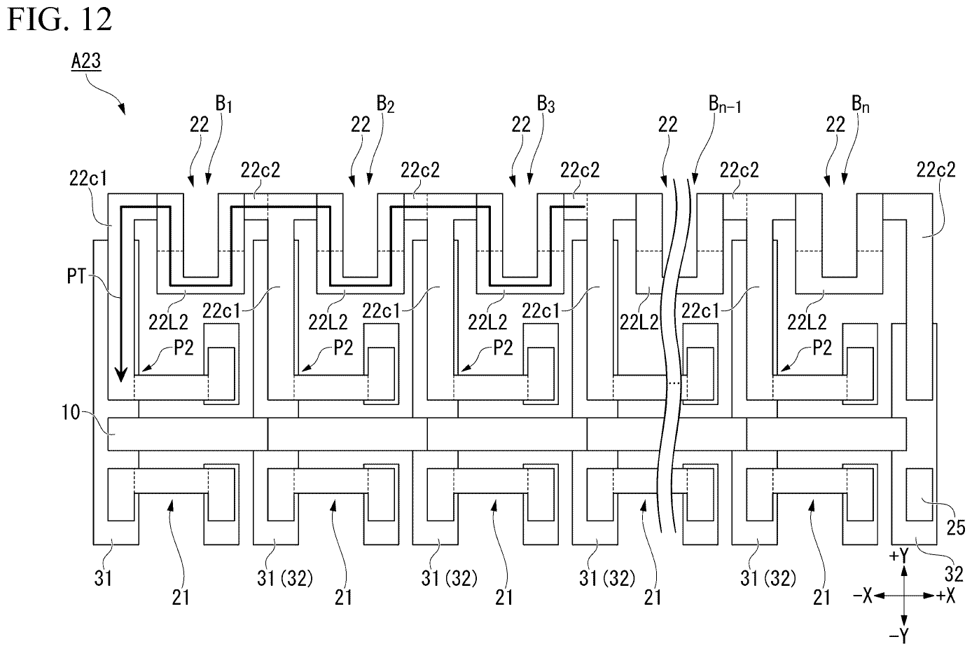

In the digital phase shifter A23 shown in FIG. 12, the second loop line section 22L2 of the loop line 22L in each of the digital phase shift circuits B₁, B₂, B₃, . . . , Bₙ₋₁, and Bₙ is convex toward the signal line 10 side. The digital phase shifter A22 according to the present modification example has a smaller dimension in the crossing direction than that of the digital phase shifter A1 shown in FIG. 6.

As shown in FIG. 12, in the present modification example, a portion that is the via pad VP11 of the first crossing line 22c1 and a portion that is the via pad VP12 of the second crossing line 22c2, which are included in the first loop line section 22L1, extend toward the front side (−Y side). The second loop line section 22L2 of the present modification example is in a state where the second loop line section 22L described in the above embodiments and the like is rotated by 180 degrees in plan view (or is axisymmetric about a straight line extending in the longitudinal direction X as an axis), and the via pad VP21 is disposed to overlap the via pad VP12 in the up-down direction Z, and the via pad VP22 is disposed to overlap the via pad VP11 in the up-down direction Z.

Although the digital phase shift circuits and the digital phase shifters according to the embodiments of the present disclosure have been described above, the present disclosure is not limited to the embodiments, and can be freely changed within the scope of the present disclosure. For example, in the embodiments described above, a digital phase shift circuit (hereinafter, referred to as an “UP-DOWN type digital phase shift circuit”) in which the second loop line section 22L2 constituting the loop line 22L is formed in an outer layer (+Z side layer) relative to the first loop line section 22L1 has been described as an example. However, a digital phase shift circuit (hereinafter, referred to as a “DOWN-UP type digital phase shift circuit”) in which the second loop line section 22L2 is formed in an inner layer (−Z side layer) relative to the first loop line section 22L1 may be adopted.

In general, in a semiconductor having a multilayer structure, a wiring line is formed to have a smaller thickness from a surface toward an inner layer. Therefore, in the DOWN-UP type digital phase shift circuit, the thickness of the second loop line section 22L2 can be made smaller than the thickness of the first loop line section 22L1. Therefore, the inductance of the transmission system is increased, and the propagation delay time can be increased. In addition to the thickness of the second loop line section 22L2, the width of a portion of the second loop line section 22L2 may be made smaller than the widths of other portions thereof, and a narrowed-width line section may be provided in the second loop line section 22L2. As a result, the inductance of the transmission system can be further increased, and the phase shift dependence of the amplitude can be reduced.

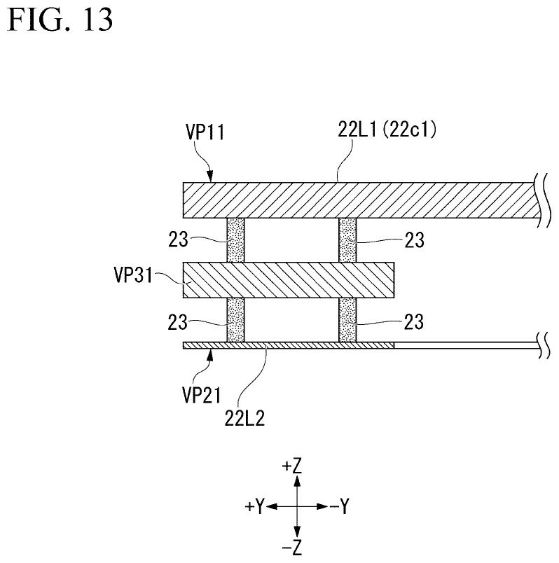

FIG. 13 is a cross-sectional view showing another configuration example of the loop line. FIG. 13 is a cross-sectional view taken along line XIII-XIII in FIG. 1 in a case where the second loop line section 22L2 of the loop line 22L is formed in an inner layer (-Z side layer) relative to the first loop line section 22L1. As shown in FIG. 13, at least one layer (third layer) in which a via pad VP31 is formed is provided between the layer (first layer) in which the first loop line section 22L1 of the loop line 22L is formed and the layer (second layer) in which the second loop line section 22L2 is formed, The digital phase shift circuit having such a loop line can be referred to as a “DOWN-DOWN-UP-UP type digital phase shift circuit”.

The via pad VP11 of the first loop line section 22L1, the via pad VP31, and the via pad VP21 of the second loop line section 22L2 are disposed to overlap each other in the up-down direction Z. The via pad VP11 of the first loop line section 22L1 and the via pad VP31 are electrically connected to each other through the plurality of vias 23.

The via pad VP31 and the via pad VP21 of the second loop line section 22L2 are electrically connected to each other through the plurality of vias 23.

That is, the loop line 22L shown in FIG. 13 has a configuration in which the first loop line section 22L1 and the second loop line section 22L2 are connected to each other through the plurality of vias 23 located above the via pad VP31 and the plurality of vias 23 located below the via pad VP31. The loop line 22L having such a configuration can achieve higher inductance than the first and second embodiments because the inductance is obtained from the two vias (the vias 23 located above and below the via pad VP31), In the configuration shown in FIG. 13, in addition to the thickness of the second loop line section 22L2, the width of a portion of the second loop line section 22L2 may be made smaller than the widths of the other portions thereof, and a narrowed-width line section may be provided in the second loop line section 22L2.

In addition, in the digital phase shifters A1 and A2 according to the first and second embodiments, the UP-DOWN type digital phase shift circuit and the DOWN-UP type digital phase shift circuit may be mixed. Further, the DOWN-DOWN-UP-UP type digital phase shift circuit may be mixed therein.

In addition, in the digital phase shifters A1 and A2 according to the first and second embodiments described above, the distance D1 (see FIGS. 1 and 7) between the center line of the second parallel line 22p2 and the center line of the third parallel line 22p3 in the crossing direction Y is the same for all of the digital phase shift circuits B₁ to Bₙ. However, the distance D1 in at least one digital phase shift circuit may be different from the distance D1 in the other digital phase shift circuits. Further, the distance D1 is not limited to two types, and may be three types or more,

### REFERENCE SIGNS LIST

10 Signal line
21 First line
21d2 Upper pad
21p1 First parallel line
22 Second line
22d Upper pad
22L Loop line
22L1 First loop line section
22L2 Second loop line section
23 Via
22w1 Straight wiring line
22w2 Loop wiring line
31 First ground conductor
32 Second ground conductor
33a, 33b Lower pad
41 First electronic switch
42 Second electronic switch
43 Third electronic switch
44 Fourth electronic switch
50 Connection conductor
60 Capacitor
A1, A2, A21 to A23 Digital phase shifter
B, B′, B₁ to Bₙ Digital phase shift circuit
VP21, VP22 Via pad
Y Crossing direction

1. A digital phase shift circuit comprising:
a signal line;
a first line including a first parallel line extending parallel to the signal line;
a second line including a second parallel line and a loop line, the second parallel line extending parallel to the signal line, and the loop line extending from one end portion of the second parallel line to a vicinity of another end portion of the second parallel line in plan view and being convex in a direction away from the signal line in a crossing direction crossing a longitudinal direction of the signal line;
a first ground conductor electrically connected to one end portion of the first parallel line and the one end portion of the second parallel line;
a second ground conductor connected to one end portion of the second line;
a first electronic switch provided between another end portion of the first parallel line and the second ground conductor; and
a second electronic switch provided between the other end portion of the second parallel line and the second ground conductor,
wherein the signal line is located between the first parallel line and the second parallel line, and
the loop line includes a first loop line section and a second loop line section, the first loop line section being formed in a first layer in which the signal line, the first parallel line, and the second parallel line are formed, and the second loop line section being electrically connected to the first loop line section through a via and being formed in a second layer different from the first layer.

2. The digital phase shift circuit according to claim 1,
wherein the second loop line section has a portion that is a narrowed-width line section having a smaller width than other portions of the second loop line section.

3. The digital phase shift circuit according to claim 1,
wherein the second loop line section has a smaller thickness than the first loop line section.

4. The digital phase shift circuit according to claim 1,
wherein the second layer in which the second loop line section is formed is an inner layer relative to the first layer in which the first loop line section is formed.

5. The digital phase shift circuit according to claim 1,
wherein both ends of the second loop line section are via pads to which the via is connected, and
a plurality of the vias are connected to each of the via pads.

6. The digital phase shift circuit according to claim 5,
wherein the vias at both ends of the second loop line section are arranged such that arrangement directions of the vias are parallel to each other or orthogonal to each other.

7. The digital phase shift circuit according to claim 6,
wherein a portion of the second loop line section other than the via pads is a narrowed-width line section having a smaller width than widths of the via pads.

8. The digital phase shift circuit according to claim 1,
wherein a via pad is formed between the first loop line section and the second loop line section in a direction of plan view, and
the first loop line section and the second loop line section are electrically connected to each other through the via pad.

9. The digital phase shift circuit according to claim 1, further comprising:
a capacitor connected to one end portion of the signal line; and
a third electronic switch provided between the capacitor and the first ground conductor,
wherein one end portion of the first ground conductor extends away from the signal line in the crossing direction and is connected to the third electronic switch.

10. The digital phase shift circuit according to claim 9,
wherein the first electronic switch, the second electronic switch, and the third electronic switch are field-effect transistors, and
sizes of the field-effect transistors forming the first electronic switch and the second electronic switch are twice or more a size of the field-effect transistor forming the third electronic switch.

11. The digital phase shift circuit according to claim 1, further comprising:
a first upper pad provided at the other end portion of the first parallel line; and
a second upper pad provided at the other end portion of the second parallel line,
wherein a maximum value of a dimension of the first upper pad in the crossing direction is larger than a width of the first parallel line, and
a maximum value of a dimension of the second upper pad in the crossing direction is larger than a width of the second parallel line.

12. The digital phase shift circuit according to claim 11, further comprising:
a first lower pad connected to the first upper pad through a via and to which the first electronic switch is connected; and
a second lower pad connected to the second upper pad through a via and to which the second electronic switch is connected,
wherein a maximum value of a dimension of the first lower pad in the crossing direction is larger than the maximum value of the dimension of the first upper pad in the crossing direction, and
a maximum value of a dimension of the second lower pad in the crossing direction is larger than the maximum value of the dimension of the second upper pad in the crossing direction.

13. The digital phase shift circuit according to claim 1, further comprising:
a fourth electronic switch provided between one end portion of the signal line and the first ground conductor.

14. A digital phase shifter comprising:
a plurality of digital phase shift circuits that are cascade-connected,
wherein each of the digital phase shift circuits is the digital phase shift circuit according to claim 1, and
the first ground conductor and the second ground conductor are integrated in a portion in which the digital phase shift circuits are adjacent to each other.
